(19) United States
(12) Patent Application Publication
(10) Pub. No.: US 2024/0237642 A1
(43) Pub. Date: Jul. 18, 2024

(54) CONTROLLED RELEASE SEMI-SOLID EMULSION FORMULATIONS OF SEMIOCHEMICALS

(71) Applicant: Pheromones Biotech LLP, Telangana (IN)

(72) Inventors: Markandeya GORANTLA, Telangana (IN); Akshitha Reddy Kaukuttla, Telangana (IN); Radha Srikrishna Maganti, Telangana (IN); Vishal Patil, Telangana (IN); Mukesh Kumar Mukul, Telangana (IN)

(73) Assignee: Pheromones Biotech LLP, Telangana (IN)

(21) Appl. No.: 18/319,718

(22) Filed: May 18, 2023

(30) Foreign Application Priority Data
Jan. 12, 2023 (IN) 202341002655

(51) Int. Cl. A01N 31/02; A01N 35/02

(52) U.S. Cl. CPC A01N 31/02; A01N 35/02

(57) ABSTRACT

The present disclosure relates to a water dispersible, semi-solid emulsion which can be applied as dollops or sprayed on plant foliage, its surfaces, any support systems in agricultural field to treat, and prevent insect population either by mass trapping, mating disruption or attract & kill technique and method of preparing the composition. The semi-solid composition comprises either semiochemical(s) alone or adsorbed on mesoporous materials or encapsulated with polymer matrix and combination thereof which displays sustained release for a longer period of time. It shows prolonged release and protects crop effectively, independent of environmental temperature and shows high stability even under humid conditions. The composition is water dispersible, eco-friendly in nature, cost-effective, exhibits stable physiochemical properties with good adhesion properties to plant surface after application and necessary rain fastness. It can be stored at room temperature with caped tube for longer time without any change in quality.

### CROSS-REFERENCE TO RELATED APPLICATION

This application claims priority to Indian Patent Application No. 202341002655, filed Jan. 12, 2023, which is incorporated herein by reference in its entirety.

### FIELD

The present disclosure relates to a controlled release semi-solid water dispersible oil-in-water emulsion formulation comprising semiochemical(s), in particular, relates to a formulation of semiochemical(s) in the form of cream or gel or paste with variable viscosity. The formulation is amenable to manual or mechanical applications in agriculture and which is compatible with or without insecticides. Further, the present disclosure relates to a semiochemical(s) delivery vehicle and/or diffuser, in a natural environment to trigger insect chemical behavioural modification for season long insect control.

### BACKGROUND

The global population is projected to increase around 9.7 billion by 2050, which will result in a tremendous demand for food. With the increase in the global population, there will be a corresponding increase in the demand for food to feed the growing population. Various strategies are being used to increase the supply of food including better irrigation for soil-based agriculture, aeroponics, hydroponics, and pest management by use of chemicals (such as insecticides, pesticides), genetic modification of plants/organisms, integrated pest management.

Insecticides have a wide application in the field of agriculture and industry. They are being used for a number of years to increase the crop yield by controlling insects that harm crops/food. However, there are many drawbacks associated with the use of insecticides, such as harmful to non-target organisms, to beneficial insects, building up of resistance by the insects, and environment. They have the potential to alter biodiversity and ecosystem components majorly and are toxic to animals as well as humans. Some insecticides become concentrated as they spread in the food chain. Traditional pest control methods rely on indiscriminate use of insecticides being sprayed at regular intervals from sowing to harvest has induced insecticide resistance.

With the growing insecticide resistance, failing genetic modification of plants/organisms and scant environmentally friendly new chemical pest control molecules in pipeline, there is a need to develop pest control technologies by way of new mechanism of action by use of nontoxic chemicals.

Insect Pheromones which are species specific have proven useful in pest control and have become essential components of crop protection as part of Integrated Pest management. The eco-friendly semiochemical based pest control strategies developed are by way of using sex pheromones for mating disruption & mass trapping, host-plant volatiles are used for attract & Kill, Push Pull techniques that have largely replacing conventional insecticides. Though very effective these semiochemical compounds are used in very high amounts and so far formulated in polymer based protective matrices. Another drawback is that they have been inefficiently deployed in field in the form of plastic dispensers (e.g., hand-applied ropes, tapes, and sachets) all of which have limited the adoption of the technology.

Semiochemical(s) (AI) intended to create semiochemical plumes or cloud or atmospheric saturation of the crop field to modify insect behavior to control the target pest require very low amounts of pheromone. However, due to inefficient diffusers a very high doses of expensive semiochemicals per treated area currently ranging from 80 grams to 250 grams per hectare, have inconsistent performances, generate plastic waste and are very expensive limiting the adoption of use of the technology. The dose presently in use and registered globally for the purpose of mating disruption use exorbitantly very high dose of pheromone than actually required. Based on existing reports on the amount of pheromone females release in environment it's obvious that we can disrupt mating with even/10 of the AI quantity presently registered and commercially in use. Thus for the technology to be adopted a diffuser which can release semiochemicals close to zero or first order and the one which is not effected by environmental variations like rain, wind, UV rays and temperature and last season long in the field will help adopt the technology replacing conventional insecticides.

Various compositions related to agrochemicals for controlling insects and methods for preparing the same are known in the art and are elucidated hereinafter. Method for the preparation of micro capsular formulations of agrochemicals comprises preparing the paste or suspension of the conventional active agrochemical ingredient in vegetable oil and dispersing the resultant paste/solution in water. Compositions to attract and kill insect pests comprising an organic biodegradable matrix component from natural sources; an organic biodegradable ultraviolet light absorbent matrix component from natural sources; a biodegradable insecticidal or acaricidal compound; and a pheromonal or kairomonal attractant and procedures to prepare it are known.

Stabilized insect mating disruption pheromone composition comprising an insect pheromone and 2,2′-Methylenebis(6-t-butyl-p-cresol) and methods of use and microcapsules containing these compositions are also known.

Fre'De'Rique M. De Lame et. al [Development and Evaluation of an Emulsified Paraffin Wax Dispenser for Season-Long Mating Disruption of Grapholita molesta in Commercial Peach Orchards. J. Econ. Entomol. 100(4): 1316Ð1327 (2007)] describes a sprayable composition with paraffin wax after emulsification with water in combination of pheromones for mating disruption of Grapholita molesta in peach orchard. The major drawback of this composition is that, the method of preparation is not disclosed, dollops were applied with the spatula or as sprayable and only focused towards application side in the agricultural field.

Gonzalez-Audino et al. [Development of natural waxes dispensers for pheromones and use in mating disruption of the ambrosia beetle Megaplatypus mutatus in poplar (Populus spp) plantations; Agroforestry Systems⋅May 20161, Monolithic solid dispensers for mating disruption of ambrosia beetle using Lanolin wax and bee wax in combination with pheromones. The system was thoroughly mixed in molten state and poured into a mold with half sphere shaped. The major drawback of this product is that, it is solid in nature and require some hanging or tying support on the plant or in agricultural field. The release rates exhibit shorter release of not more than six weeks.

U.S. Pat. No. 6,001,346 discloses a sprayable or solid formulation which uses biodegradable wax carrier for insect pheromones and a method for constant release rate of the pheromone from the biodegradable wax. A composition comprising a pheromone and paraffin wax formulated as an aqueous emulsion or in a solid form. suitable for application to a surface of a tree or crop for mating disruption of insect pests. Pheromone is released by diffusion or by partitioning from the biodegradable wax carrier or by pheromone exposure due to the biodegradable wax carrier degradation. The major drawback of this patent is that, method of preparation of formulation and composition is not clearly disclosed, type or nature of aqueous emulsion or solid is not described, release duration is very short up to three weeks and only focused towards application side in agricultural field. Additionally, other disadvantages of this formulation are that it is not water dispersible, uses very low concentration of surfactant which leads to physicochemical instability. The formulation does not describe the use of any adhesion promoter so majority of applied dollop may fall down from the plant surface.

Thus, there exists an unmet need for a semiochemical controlled release formulation for insect behaviour modification either by confusion or disorientation and mating disruption, or an attraction and kill to achieve insect control and prevent crop damage. These formulations will be an effective integrated pest management tool and will serve as a replacement to use of harmful broad-spectrum insecticides. We need cost effective, water dispersable and efficient semiochemical(s) diffuser which lasts for season long in agriculture field conditions. which also exhibits physicochemical stability under long term storage conditions and rainfastness in field after application on crop.

### BRIEF SUMMARY

Objective of the present invention is to provide a water dispersible controlled release semi solid formulation containing semiochemical(s) resistant to environmental temperature, humidity, and rainy condition, for control of insect pests which are harmful to agrarian crops by means of attract and kill technique, confusion and disorientation or mating disruption (MD) or male annihilation technique (MAT).

Another objective of the present disclosure is to provide a semisolid composition which adheres to wet/dry plant surface or any solid substrate.

Another objective of the present disclosure is to use natural mesoporous materials to regulate release of semiochemical(s) as a controlled release material.

Another objective of the present disclosure is to use high surface area carbon for adsorption of semiochemical(s) for controlled release.

Another objective of the present disclosure is to use minimum amount of semiochemical(s) to achieve season long insect behaviour modification lasting at least a minimum of 2 months and up to 5 months.

Still another objective of the present disclosure is to provide a composition which is amenable to various forms of application systems, to deliver required amount of formulation or composition in the field. Yet another objective of the present disclosure is to provide a process for the preparation of controlled release semi solid composition.

Still another objective of the present disclosure is to provide water dispersible property to aid addition of insecticide, which can be used for attract and kill strategy with compatible chemical insecticides.

Another objective of the present disclosure is to provide an eco-friendly, stable, non-phytotoxic, cost-effective, biodegradable and insect specific semiochemical(s) controlled release system, which is alternative to existing chemical/bio pesticide systems. The formulation can be prepared with variable viscosity to suit various crops, geographies and equipment used for application. The formulation can be packed and stored in a laminated tubes and applied on the plant foliage or tree surface or any other surface in agricultural field.

Other objectives and advantages of the present disclosure will be more apparent from the following description, which is not intended to limit the scope of the present disclosure.

In some aspects, the present disclosure relates to controlled release, semi-solid composition comprising semiochemical(s) specifically pheromones incorporated in waxy matrix. The composition provides a crop specific semi-solid, water dispersible wax emulsion for controlled release of semiochemical(s). The paste delivery system is designed to release pheromones for the entire crop season for protection against insect pests by modifying the insect behaviour. The composition in the form of cream or gel or paste when dispensed in field in the form of tiny to large source points to create consistent semiochemical(s) plumes that are competitively attractive against a targeted insect pest for a given treated area. Specifically, plumes of semiochemical(s) are released under challenging environmental conditions.

In some embodiments, the present disclosure relates to controlled release semiochemical(s), a water dispersible semi solid, and oil in water emulsion composition comprising wax-based composition that comprises semiochemical(s) to control insect pests by attraction and kill technique, confusion and disorientation or mating disruption and provides semiochemical(s) release duration up to twelve weeks or more in agricultural field and is stable for minimum of 2 years at room temperature.

### DESCRIPTION OF THE FIGURES

The present disclosure will now be described with the help of the accompanying drawing, in which:

FIG. 1 illustrates the Comparative Release data graph of controlled release paste in modified synthetic microcrystalline wax (MC) and a natural rice bran (RB) wax with Lobesia AI;

FIG. 2 illustrates the Comparative Release data graph of controlled release of semi-solid paste formulation in open field with selected AI, FAW, BFSB, TUTA, OFM, ME, Lobesia, NOW, CYDIA.

FIG. 3 illustrates the Comparative Release data graph of controlled release of semi-solid paste in open field with selected AI, FCM, RPW, RYSB, RHY, HELICO, BFSB;

FIG. 4 illustrates the Comparative Release data graph of controlled release of semi-solid paste of PBW in open field for 120 days.

FIG. 5 illustrates the Comparative Release data graph of controlled release of semi-solid paste in open field of actives with different carbon chain length.

FIG. 6 illustrates the Comparative Release data graph of controlled release of semi-solid paste in open field using modified MC wax.

FIG. 7 illustrates the Comparative Release data graph of controlled release of semi-solid paste in open field using modified Rice Bran wax.

FIG. 8 depicts additional Comparative Release data graph of controlled release of exemplary semi-solid paste formulation in open field.

### DETAILED DESCRIPTION

Embodiments are provided to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an”, and “the” may be intended to include the plural forms as well, unless the context clearly suggests otherwise. The terms “comprise”, “comprising”, “including” and “having” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

Throughout this specification the word “comprise of”, or variations such as “comprises” or “comprising”, will be understood to imply the inclusion of a stated element, integer or step, or group of elements, integers, or steps, but not the exclusion of any other element, integer or step, or group of elements, integers, or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of experiment only and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

The abbreviations used in the present disclosure have the meaning as specified below unless mentioned otherwise:

### Abbreviations

PVA: Poly vinyl alcohol
PVP: Poly vinyl pyrrolidone
BHT: Butylated hydroxytoluene
BHA: Butylated hydroxyl anisole
Neusilin US2: Magnesium Alumino metasilicate,
SBA 15/Syloid 244P/Syloid XPP: Mesoporous silica,
UV screeners: Charcoal & titanium dioxide
MCW: Microcrystalline wax
TML: Trimedlure
RHY: Rhinoceros
ME—Methyl eugenol
CL—Cuelure
Carbon HBET—carbon derived from organic source having surface area >2000 m²/g
AI: active ingredient, e.g., semiochemical(s)

Table-1 as provided below provides a list of pheromones and its abbreviated forms as used in the current specification.

TABLE 1

| Brand Name | Active Blend |
|---|---|
| PBW | (Z,Z)-7,11-hexadecadien-1-yl acetate |
| | (Z,E)-7,11-hexadecadien-1-yl acetate |
| FAW | Z9-Tetradecenyl acetate |
| | Z7-Dodecenyl acetate |
| | Z11-Hexadecenyl acetate |
| BFSB | E-11-hexadecen-1-yl acetate |
| | (E)-11-hexadecen-1-ol |
| TUTA | 3E,8Z,11Z-Tetradecatrienyl acetate |
| | 3E,8Z-Tetradecadienyl acetate |
| CLM | (Z,Z,E)-7,11,13-Hexadeca trien-1-al |
| DBM | Z-11-Hexadecenal |
| | Z-11-Hexadecenyl-1-acetate |
| | Z-11-Hexadecenol |
| RYSB | Z-11-Hexadecenal |
| | Z-9-Hexadecenal |
| Helico | Z-11-Hexadecenal |
| | Z-9-Hexadecenal |
| Spodo | (Z,E)-9,11-Tetradecadienyl acetate |
| | Z9,E-12-Tetradecadienyl acetate |
| TMB | Cis-3-Hexenyl acetate |
| | 2E-Hexen-1-ol |
| PSB | Z-11-Hexadeceny1-1-acetate |
| | Z-11-Hexadecenol |
| ESB | Z-11-Hexadecenol |
| EC | (7Z,9E)-Dodeca-7,9,11-trien-1-yl formate (Carob |
| | moth) |
| NOW | 11Z,13Z-Hexadeca dienal |
| RPW | 4 methyl 5 nonanol |
| | 4 methyl 5 nonanone |
| Rhino/RHY | Ethyl-4-Methyl octanoate |
| ME | Methyl eugenol |
| CL | Cuelure |
| CM | (E,E)-8,10-Dodecadien-1-ol |
| OFM | (Z)-8-Dodecen-1-yl acetate |
| | (E)-8-Dodecen-1-yl-acetate |
| | (Z)-8-Dodecen-1-ol |
| PB | (1R)-cis-4,6,6-Trimethylbicyclo [3.1.1] hept-3-en- |
| | 2-one |
| WFT | Methyl Isonicotinate |
| Profuze | trans-3,7-Dimethyl-2,6-octadien-1-ol |
| | cis-3,7-Dimethyl-2,6-octadien-1-ol |
| Terpenes | Mono terpenes Terpene |
| | alcohols |
| ISB | Z-13-Octadecynyl acetate |
| | Z-13-Octadecenol |
| LPB | (E,E)-10,12-hexadecadienal |
| | (E, E)-10,12-hexadecadienol |
| | E-10-hexadecenal |
| SE | Z,E-9,12-Tetradecadien-1-yl-Acetate |
| | Z-9 Tetradecenol |
| FCM | (Z)-8-Dodecen-1-yl acetate |
| | (E)-8-Dodecen-1-yl-acetate |
| Lobesia | 7E,9Z Dodecadienyl acetate |
| — | Beta Ionone, Alpha Ionone |
| — | ethyl tiglate, |
| — | γ-octalactone |
| — | 1-octen-3-ol |
| — | 3-careneγ-octalactone |
| — | 1-octen-3-ol |
| — | acetoin, methionol |
| — | 3-carene |

### Semiochemical Composition

In some variations, the present invention discloses a water dispersible semisolid composition comprising ingredients which confer composition the desired properties detailed herein. In some embodiments, some ingredients and their functions may include:
1. Rice Bran wax as a base including natural and synthetic oils and waxes;
2. Combination of Surfactants or emulsifiers from the group of cetostearyl alcohol, Lecithin, cetyl alcohol, stearyl alcohol, stearic acid, montanic acid, oleic acid, polyhydroxy alcohol, phospholipid, along with Brij's, span's and tween's;
3. Magnesium stearate, Zinc stearate as water repelling/texture modifying agents;
4. Controlled release mesoporous materials and Carbon HBET;
5. Polymer as rheology modifier and adhesion promoter,
6. Humectant/stabilizer, and/or
7. Preservatives.

In some embodiments, the composition provided herein uses rice bran as base wax for semiochemical(s) pheromone-based insect pest control paste formulation. In some embodiments, the use of rice bran as base wax reduces the manufacturing cost and phytotoxicity of the composition due to the easy availability of rice and the naturality of its contents such as oils and wax.

In some embodiments, the composition provided herein may comprise all natural and synthetic oils and waxes. In some embodiments, the composition provided herein may comprise polymers for semiochemical(s)-based insect pest control system.

In some variations, provided herein is a semiochemical composition that is a semi-solid oil-in-water emulsion, comprising a dispersed phase and a dispersion medium. In some embodiments, the dispersed phase comprises a semiochemical, a wax, a mesoporous material, a long chain saturated or unsaturated fatty acid or/and alcohol, a diluent, and an antioxidant. In some embodiments, the mesoporous material is present in an amount of up to 20 w/w % (e.g., up to any of 18 w/w %, 16 w/w %, 14 w/w %, 12 w/w %, 10 w/w %, 8 w/w %, 6 w/w %, or 4 w/w %) of the dispersed phase, In some embodiments, the long chain saturated or unsaturated fatty acid or/and alcohol is present in an amount up to 20 w/w % (e.g., up to any of 18 w/w %, 16 w/w %, 14 w/w %, 12 w/w %, 10 w/w %, 8 w/w %, 6 w/w %, or 4 w/w %) of dispersed phase. In some embodiments, the dispersion medium comprises an additive. In some embodiments, the additive comprises more than one types of additives. In some embodiments, the additive is present in an amount of at least 1 w/w % (e.g., at least any of 1.2 w/w %, 1.4 w/w %, 1.6 w/w %, 1.8 w/w %, 2 w/w %, 2.2 w/w %, 2.5 w/w %, or 3 w/w %) of the total amount of the dispersion medium. In some embodiments, the additive is present in an amount of no more than 50 w/w % (e.g., no more than 45 w/w %, no more than 40 w/w %, no more than 35 w/w %, or no more than 30 w/w %) of the total amount of the dispersion medium. In some embodiments, the additive is present in an amount of about 2 to 30 w/w % of the total amount of the dispersion medium.

In some embodiments, provided herein is a semiochemical composition that is a semi-solid oil-in-water emulsion, comprising a dispersed phase and a dispersion medium,
wherein the dispersed phase comprises:
   semiochemical,
   wax,
   mesoporous material, present in an amount of up to 10 w/w % of the dispersed phase, long chain saturated or unsaturated fatty acid or/and alcohol, in an amount up to 10 w/w % of dispersed phase,
   diluent, and
   antioxidant, and
wherein the dispersion medium comprises:
   additive, present in an amount of about 2 to 30 w/w % of the total amount of the dispersion medium.

In some embodiments, the dispersed phase and dispersion medium are present in a weight ratio of at least 0.5:1 (e.g., at least any of 0.6:1, 0.7:1, 0.8:1, 0.9:1, or 1:1). In some embodiments, the dispersed phase and dispersion medium are present in a weight ratio of no more than 2:1 (e.g., no more than any of 1.8:1, 1.5:1, 1.3:1, 1:1, or 0.8:1). In some embodiments, the dispersed phase and dispersion medium are present in a weight ratio of about 1:1. In some embodiments, the dispersed phase is present in an amount of about 0.1 w/w % to about 60% w/w % (e.g., about any of 0.1 w/w % to 50% w/w %, 0.1 w/w % to 0% w/w %, 10 w/w % to 60% w/w %, 20 w/w % to 60% w/w %, 30 w/w % to 60% w/w %, 40 w/w % to 60% w/w %, 30 w/w % to 50% w/w %, or about 50 w/w %) of the total composition. In some embodiments, the dispersion medium is present in an amount of about 0.1 w/w % to about 60% w/w % (e.g., about any of 0.1 w/w % to 50% w/w %, 0.1 w/w % to 0% w/w %, 10 w/w % to 60% w/w %, 20 w/w % to 60% w/w %, 30 w/w % to 60% w/w %, 40 w/w % to 60% w/w %, 30 w/w % to 50% w/w %, or about 50 w/w %) of the total composition. In some embodiments, the semiochemical composition comprises a dispersed phase and a dispersion medium, wherein the dispersed phase is present in an amount of about 50 w/w % of the total composition, and the dispersion medium is present in an amount about 50 w/w %. In some embodiments, the semiochemical composition is a semi-solid emulsion. In some embodiments, the emulsion is an oil-in-water emulsion.

In some embodiments, the semi-solid emulsion composition comprises:
(a) Dispersed phase in an amount in the range of 0.1 to 50 w/w % of the total amount of the composition;
(b) Dispersion medium component in an amount in the range of 0.1 to 50 w/w % of the total amount of the composition; wherein the dispersion medium comprises an additive, and the additive is in an amount in the range of 0.01 to 15% of the total amount of the dispersion medium.

In some embodiments, the additive comprises stabilizer, pH modifier, humectant, preservative, lubricant/texture modifier, diluent, antioxidant, or any combination thereof. In some embodiments, the additive comprises more than one types of additives.

In some embodiments, the composition exhibits one or more of the following properties (i)-(iv):
(i) rainfastness;
(ii) non-phytotoxicity to plant surface;
(iii) controlled release of semiochemical(s) for a minimum of about eight weeks; and
(iv) stability and controlled release of semiochemical(s) under environmental variations.

In some embodiments, the composition exhibits rainfastness. In some variations, the term “rainfastness” may refer to the percent retention of the applied composition on plant is at least 60% (e.g., at least any of 65%, 70%, 75%, or 80%) despite a gentle spray of water such as rainfall. In some embodiments, the composition exhibits rainfastness such that during a season long crop cycle, notwithstanding the rainy seasons, the percent retention of the applied composition on plant is at least 60% (e.g., at least any of 65%, 70%, 75%, or 80%). In some embodiments, the rainfastness may refer to the degree of effectiveness of the applied composition to be retained notwithstanding a gentle spray of water, such as by rainfall. In some embodiments, the degree of effectiveness of the applied composition during a rainy season is no less than 60% (e.g., no less than any of 65%, 70%, 75%, or 80%) of the effectiveness when there is no rainfall. In one variation, the composition exhibits rainfastness such that despite rainy seasons, the applied composition provides an effective amount of semiochemical per hectare required to control the pest population during the season long crop cycle

In some embodiments, the composition is non-phytotoxicity to plant surface. In some embodiments, “phytotoxicity” may refer to a delay of seed germination, inhibition of plant growth, or other typical adverse effect on plants. In some embodiments, the composition control pest populations while not causing damage to plants. In some embodiments, the composition is not phytotoxicity such that when applied to a plant field, such as cotton field, the average yield is increased by at least 30% (e.g., at least 35%, 40%, or 45%) and no damage to plants are observed.

In some embodiments, the composition exhibits controlled release of the semiochemical. In some embodiments, controlled release refers to a steady zero or first order release of the semiochemical for at least eight weeks. In some embodiments, each gram of the composition comprises about 1 mg to about 20 mg of the semiochemical. In some embodiments, the composition has a release rate of about 1 mg to about 40 mg (e.g., about any of 1 mg to 30 mg, 1 mg to 25 mg, or 1 mg to 20 mg) semiochemical per day per gram of the composition. In some embodiments, the composition exhibits controlled release (e.g., steady zero or first order release) of the semiochemical for at least about six weeks (e.g., at least about any of six, seven, eight, nine, ten, eleven, twelve, thirteen, fourteen, or fifteen weeks). In some embodiments, the composition has a release rate of about 1 mg to 20 mg semiochemical per day per gram of the composition over a period of at least eight weeks.

In some embodiments, the composition exhibits stability under fluctuation of environmental conditions, such as rain, wind, UV rays, and temperature fluctuation. In some embodiments, the stability may include physical stability and chemical stability. In some embodiments, the composition remains as an oil-in-water emulsion and does not exhibit phase separation under fluctuation of environmental conditions.

In some embodiments, the composition exhibits one, two, three, or four of (i) rainfastness; (2) non-phytotoxicity to plant surface; (iii) controlled release of semiochemical(s) for a minimum of about eight weeks; and (iv) stability and controlled release of semiochemical(s) under drastic environmental variations. In some embodiments, these features are provided by the components in the composition. In some embodiments, such components may include a strong hydrophobic component, an emulsion component, an encapsulating agent, stabilizer(s) or emulsion stabilizer(s), film forming agents, preservative(s), an antioxidant, UV Screeners, a diluent, lubricating agents, or any combination thereof.

In accordance with the embodiments of the present disclosure, the semi-solid composition of semiochemical(s) is capable of controlling the pest either through mating disruption or mass trapping by using mechanical devices or can be used to attract and kill strategies in combination with insecticides.

In an embodiment of the present disclosure, the dispersed phase comprises:
(a) wax as a carrier in an amount in the range of 1 w/w % to 50 w/w % of the total amount of the composition;
(b) oil in an amount in the range of 0.01 w/w % to 15 w/w % of the total amount of the composition;
(c) semiochemical(s) in an amount in the range of 0.01 w/w % to 20 w/w % of the total amount of the composition; and
(d) antioxidant in an amount in the range of 0.01 w/w % to 10 w/w % of the total amount of the composition.

In some embodiments, the dispersed phase comprises:
(a) a semiochemical either alone or encapsulated in a polymer matrix or both, or in microcapsules with core-shell structure, or premixed with or adsorbed into the mesoporous material, or embedded in wax, or any combination thereof, present in an amount of about 0.1 to 20 w/w %;
(b) a wax present in an amount of about 0.1 to 50 w/w % of the total composition;
(c) a long chain saturated or unsaturated long chain fatty acid/alcohol present in an amount of about 0.1 to 20 w/w % of the total composition;
(d) a diluent present in an amount of about 0.1 to 15 w/w % of the total composition; and
(e) an antioxidant is present in an amount of about 0.01 to 6 w/w % of the total composition.

In some embodiments, the dispersed phase further comprises a lubricant or texture modifier. In some embodiments, the lubricant or texture modifier is present in an amount of about 0.1 to 10 w/w % of the total composition. In some embodiments, the lubricant or texture modifier is present in an amount of at least 0.01 w/w % (e.g., at least 0.04 w/w %, 0.08 w/w %, 0.1 w/w %, 0.15 w/w %, 0.2 w/w %, 0.5 w/w %, 1 w/w %, or 2 w/w %) of the total composition. In some embodiments, the lubricant or texture modifier is present in an amount of no more than 20 w/w % (e.g., no more than any of 18 w/w %, 15 w/w %, 13 w/w %, 10 w/w %, 8 w/w %, or 5 w/w %) of the total composition.

In some embodiments, the texture modifier comprises magnesium stearate, zinc stearate, blend of esters of behenic acid with glycerol, or any combination thereof. In some embodiments, metallic stearates are used as texture modifier as well as emulsion stabilizers, along with other emulsion stabilizers such as Tween 60/Polysorbate 60, Comprittol 888. Propylene glycol acts as humectants and Span 60, Span 60 acts as the composition stabilizers. In some embodiments, the texture modifier, such as magnesium stearate and zinc stearate, also acts as water repellent. In some embodiments, the lubricant or texture modifier comprises metallic stearate. In some embodiments, the lubricant or texture modifier comprises magnesium stearate, zinc stearate, or calcium stearate, or a combination thereof.

In some embodiments, the dispersion medium further comprises emulsifier, present in an amount of about 0.1 w/w % to 20 w/w % by of the total amount of dispersion medium. In some embodiments, the emulsifier is present in an amount of at least 0.01 w/w % (e.g., at least 0.04 w/w %, 0.08 w/w %, 0.1 w/w %, 0.15 w/w %, 0.2 w/w %, 0.5 w/w %, 1 w/w %, or 2 w/w %) of the total amount of dispersion medium. In some embodiments, the emulsifier is present in an amount of no more than 20 w/w % (e.g., no more than any of 18 w/w %, 15 w/w %, 13 w/w %, 10 w/w %, 8 w/w %, or 5 w/w %) of the total amount of dispersion medium.

In some embodiments, the long chain saturated fatty acids/alcohols act as an emulsifier. In some embodiments, the emulsifier comprises cetostearyl alcohol, Lecithin, cetyl alcohol, stearyl alcohol, stearic acid, montanic acid, oleic acid, polyhydroxy alcohol, phospholipid, Brij50, Brij 52, Brij 30, Brij 35, Brij 90, Brij 92, Span 20, Span 40, Span 60, Span 80, tween 20, tween 40, tween 60, and tween 80, or any combination thereof. In some embodiments, the long chain saturated fatty acids/alcohols comprise cetostearyl alcohol, cetyl alcohol, stearyl alcohol, stearic acid, montanic acid, oleic acid, or polyhydroxy alcohol, or any combination thereof.

In some embodiments, the antioxidant comprises BHT, BHA, tocopherol, or any combination thereof.

In some embodiments, the additive comprises one or more additives. In some embodiments, the additive comprises a stabilizer, a humectant, a preservative, a rheology modifier, an adhesion promoter, or film former, or a UV screening agent, or any combinations thereof.

In some embodiments, the additive comprises:
film forming or adhesion promoting agent, present in an amount in the range of about 0.1 to 7.5 w/w % of the total amount of the composition;
preservative, present in an amount of about 0.01 to 0.5 w/w % of the total amount of the composition;
stabilizer, present in an amount of about 0.1 to 10 w/w % of the total amount of the dispersion medium;
UV screening agent and controlled release materials, present in an amount of about 0.1 to 10 w/w % of the total amount of the composition; and
rheology modifier, present in an amount of about 0.1 to 10 w/w % of the total amount of the composition.

In some variations, the semiochemical is present alone in the composition described herein. In some embodiments, the semiochemical is encapsulated in a polymer matrix. In some embodiments, the polymer can be a natural or a synthetic polymer. In some embodiments, the polymer may include gelatine, alginates, chitin, aminoplast resin, the alkoxy cellulose or its derivatives, poly urea derivatives, or methacrylate coated particles, or any combination thereof.

In some embodiments, the semiochemical is embedded in wax particles. In some embodiments, the wax comprises natural wax, synthetic wax or a combination thereof. In some embodiments, the synthetic wax comprises microcrystalline wax, ozokerite, ceresin, Montan wax, paraffin or any combination thereof. In some embodiments, the natural wax comprises rice bran wax, sunflower wax, bees wax, candelilla wax, carnauba wax, Chinese insect wax, esparto wax, Japan wax, spermaceti wax, lanolin wax, or any combination thereof. In some variations, the semiochemical(s) may be entrapped within the wax carrier, along with an emulsifier, and additive components that are homogeneously dispersed in the dispersion medium.

In some embodiments, the semiochemical is premixed with or adsorbed into the mesoporous material. In some embodiments, the mesoporous material is a nano-structured material. In some embodiments, the premix matrix is used in combination with carbon in an amount in the range of 1 to 10 w/w % of the total formulation for prolonged release of semiochemical(s).

In some embodiments, the nano-structured material comprises activated charcoal, carbon, graphite sourced carbon, carbon particles derived from natural organic substrate, or any combination thereof. In some embodiments, the mesoporous material is a nano-structured material, and the nano-structured material comprises, for example, silica or amorphous uniform monodisperse spherical carbon particles derived from natural organic substrate. In some embodiments, the mesoporous material may have a BET surface area of at least about 2000 m²/g (e.g., at least 2500 m²/g) when measured using nitrogen adsorption method.

In some embodiments, the ratio of the semiochemical to the mesoporous material or nano-structured material in the premix matrix is in a weight ratio of 1:10 to 10:1. In some embodiments, the ratio of the semiochemical to the mesoporous material or nano-structured material in the premix matrix is in a weight ratio of about 3:1. In some embodiments, the ratio of the semiochemical to the mesoporous material or nano-structured material in the premix matrix is in a weight ratio of about 2:1.

In some embodiments, the semiochemical(s) comprises at least one selected from the group consisting of pheromone(s), allomone(s), kairomone(s), synomone including comprising sex semiochemical(s) and/or attractant, and combinations thereof. In some embodiments, the semiochemical may be used alone or premixed with the mesoporous material, or embedded in the wax. In some embodiments, the semiochemical is a pheromone.

In some variations, the semiochemical is the blend of (Z, Z)-7,11-hexadecadien-1-yl acetate and (Z, E)-7,11-hexadecadien-1-yl acetate; the blend of Z-9-Tetradecenyl acetate, Z-7-Dodecenyl acetate and Z-11-Hexadecenyl acetate; the blend of (E)-11-hexadecen-1-yl acetate and (E)-11-hexadecen-1-ol; the blend of 3E,8Z,11Z-tetradecatrienyl acetate and 3E,8Z-tetradecadienyl acetate; (Z,Z,E)-7,11,13-hexadeca trien-1-al; the blend of Z-11-hexadecenal, Z-11-hexadecenyl-1-acetate and Z-11-Hexadecenol; the blend of Z-11-hexadecenal and Z-9-hexadecenal; the blend of Z-11-hexadecenal and Z-9-hexadecenal; the blend of (Z,E)-9,11-tetradecadienyl acetate and Z9,E-12-tetradecadienyl acetate; the blend of cis-3-hexenyl acetate and 2E-hexen-1-ol; the blend of Z-11-hexadecenyl-1-acetate and Z-11-hexadecenol; the active of Z-11-hexadecenol; the active of (7Z,9E)-dodeca-7,9,11-trien-1-yl formate; 1 Z,13Z-hexadeca dienal; the blend of 4-methyl-5-nonanol and 4-methyl-5-nonanone; ethyl-4-methyl octanoate; methyl eugenol; the blend of methyl eugenol and cuelure; (E,E)-8,10-dodecadien-1-ol; (Z)-8-dodecen-1-yl acetate, (E)-8-dodecen-1-yl-acetate and (Z)-8-dodecen-1-ol; (1R)-cis-4,6,6-trimethylbicyclo [3.1.1]hept-3-en-2-one; trans-3,7-dimethyl-2,6-octadien-1-ol and cis-3,7-dimethyl-2,6-octadien-1-ol; the blend of Z-13-octadecynyl acetate and Z-13-octadecenol; the blend of (E,E)-10,12-hexadecadienal, (E,E)-10,12-hexadecadienol and E-10-hexadecenal; the blend of Z,E-9,12-tetradecadien-1-yl-acetate and Z-9 tetradecenol; the blend of (Z)-8-dodecen-1-yl acetate and (E)-8-dodecen-1-yl-acetate; (7E,9Z) dodeca-7,9-dien-1-yl acetate; Beta Ionone; Alpha Ionone; ethyl tiglate; γ-octalactone; 1-octen-3-ol; 3-careneγ-octalactone; acetoin; methionol; 3-carene; 4-vinyl anisole; methyl isonicotinate; mono terpenes and terpene alcohols, or any combination thereof.

Other pheromones that may be used as semiochemicals in the present disclosure may include (Z,Z,E)-3,6,8-Dodecatrien-1-ol, (E, E)-10,14-Hexadecadienal (Z,Z)-9,2-Tetradecadien-1-ol, (Z,Z)-9,12-Tetradecadienyl acetate, (Z,Z)-9,11-Tetradecadienyl acetate, (Z,Z)-8,0-Tetradecadienai 1, (Z,Z)-8,10-Dodecadienyi acetate, (Z,Z)-11,13-Hexadecadienyl acetate, (Z,Z)-8,10-Dodecadien-1-ol, (Z,Z)-11,13-Hexadecadien-1-ol, (Z,Z)-7,9-Dodecadienyl acetate, (Z,Z)-10,12-Hexadecadienal, (Z,Z)-7,9-Dodecadien-1-ol, (Z,E)-10,12-Hexadecadienai, (Z,Z)-7,11-Tridecadienyl acetate, (Z)-11-Heptadecenyl acetate, (Z,Z)-5,9-Tridecadieny acetate, (Z)-11-Heptadecen-1-ol, (Z,Z)-5,8-Tetradecadienyl acetate, (Z,Z)-5,8-Tetradecadien-1-ol, (Z,Z,Z)-9,12,15-Octadecatrienal, (Z,Z)-5,8-Tetradecadienal, (Z,Z)-5,7-Dodecadienal, (E, E)-10,12-Hexadecadien-1-ol, (Z,Z)-4,7-Tridecadienyl acetate, (Z)-8-Heptadecen-1-ol, (Z,Z)-4,7-Tridecadien-1-ol, (E)-8-Heptadecenyl acetate, (Z,Z)-4,7-Decadienyl acetate, (Z,Z)-9,11-Pentadecadienal, (Z,Z)-4,7-Decadien-1-ol, (E,Z)-9, II-Pentadecadienal, (Z,Z)-3,8-Dodecadien-1-ol, (Z,E)-7,11-Hexadecadienal, (Z,Z)-2,4-Decadienal, (E,Z)-8,10-Pentadecadienyl acetate, (Z,Z)-9,12-Tetradecadienal, (Z,E)-9,12-Tetradecadienal, (Z,Z)-9,11-Tetradeeadien-1-ol, (Z,Z)-5,7-Dodecadienyl acetate, (Z,Z)-9,11-Hexadecadienal, (Z,E,E)-3,6,8-Dodecatrien-1-ol (Z,Z)-11,13-Hexadecadienal, (Z,E)-9,11-Teiradecadienyl acetate, (Z,E)-8,10-Dodecadienyl acetate, (Z,E)-11,13-Hexadecadienyl acetate, (Z,E)-7,9-Dodecadienyl acetate, (Z,E)-10,12-Hexadecadienyl acetate, (Z,E)-7,9-Dodecadien-1-ol, (E,Z)-10,12-Hexadecadienal, (Z,E)-5,7-Dodecadienyl acetate, (E,Z)-9,11-Hexadecadienal, (Z,E)-5,7-Dodecadienal, (Z,E)-9,1-Hexadecadienal, (Z,E)-3,5-Tetradecadienyl acetate. (Z,Z)-9,12-Octadecadienal, (Z,E)-3,5-Dodecadienyi acetate, (Z,E)-7,11-Hexadecadienyl acetate, (Z,E)-3,5-Decadienyl acetate, (Z,Z)-8,10-Pentadecadienyl acetate, (Z,E)-5,9-Tridecadienyl acetate, (E)-10-Heptadecenyl acetate, (Z, E)-9,12-Tetradecadienyl acetate, (Z,E)-9,12-Tetradecadienal, (Z,E)-9,12-Tetradecadien-1-ol, (Z,E)-9,11-Tetradecadienal, (Z,E)-9,11-Tetradecadien-1-ol, (Z. E)-8,10-Tetradecadienyl acetate. (Z, E)-8,10-Dodecadienal, (Z,E)-1,13-Hexadecadienal, (Z, E)-8,10-Dodecadien-1-ol, (Z,E)-11,13-Hexadecadien-1-ol, (Z, E)-5,7-Dodecadien-1-ol, (E,Z)-9,1-Hexadecadienyl acetate, (Z,E)-8,10-Tetradecadien-1-ol, (Z)—S-Tetradecenyi acetate, (Z)-13-Octadecen-1-ol, (Z)-10-Tridecenyl acetate, (E,E,Z,Z)-4,6,11,13-Hexadecatetraenal, (Z)-10-Tetradecenyl acetate, (Z,Z)-2,13-Octadecadien-1-ol, (Z)-10-Dodecenyi acetate, (Z,Z)-7,11-Hexadecadienyl acetate, (Z)-9-Undecenyl acetate, (E)-6-Hexadecenyl acetate, (Z)-9-Tridecenyl acetate, (E,E,Z)-10,12,14-Hexadecatrienal, (Z)-9-Tetradecenyl acetate, (E,Z)-2,13-Octadecadienyi acetate, (Z)-9-Tetradecenal, (E,Z)-2,13-Qctadecadienai, (Z)-9-Tetradecen-1-ol, (E,Z)-2,13-Octadecadien-1-ol, (Z)-9-Dodecenyl acetate, (E,Z)-4,6-Hexadecadien-1-ol, (Z)-9-Dodecenal, (E,Z)-4,6-Hexadecadienyl acetate, (Z)-9-Dodecen-1-ol, (E,E)-1,3-Hexadecadien-1-ol, (Z)-8-Undecenyl acetate, (Z)-5-Hexadecenyl acetate, (Z)-8-Trideceny! acetate, (E,E,E)-10,12,14-Hexadecatrienai, (Z)-8-Tetradecenal, (Z)-3-Octadecenyl acetate, (Z)-8-Tetradecen-1-ol, (E)-13-Octadecenai, (Z)-8-Dodecenyl acetate, (Z)-9-Hexadecenyl acetate, (Z)-8-Dodecenyl acetate, (Z)-12-Hexadecenyl acetate, (Z)-8-Dodecen-1-ol, (Z)-11-Hexadecenal, (Z)-7-Tridecenyl acetate, (Z,Z,E)-7,11,13-Hexadecatrienal, (Z)-7-Tetradecenyl acetate, (Z)-11-Octadecenyl acetate, (Z)-7-Tetradecenai, (Z)-11-Octadecenal. (Z)-7-Tetradecen-1-ol, (Z)-1-Octadecen-ol, (Z)-7-Dodecenyl acetate (E)-11-Hexadecen-1-ol, (Z)-7-Dodecenal, (E)-11-Hexadecenyl acetate, (Z)-7-Dodecen-1-ol, (Z)-10-Hexadecenal, (Z)-7-Decenyl acetate, (Z,Z)-6,9-Pentadecadienyi acetate, (Z)-6-Tetradecenyl acetate, (Z)-9-Octadecenal, (Z)-5-Undecenyl acetate (E)-5-Hexadecenyl acetate. (Z)-5-Tetradecenyl acetate (E)-9-Octadecenal, (Z)-5-Tetradecenai, (Z)-9-Octadecen-1-ol, (Z)-5-Tetradecen-1-ol, (E)-9-Octadecenyl acetate, (Z)-5-Dodecenyl acetate (E)-9-Hexadecenyl acetate, (Z)-5-Dodecenal, (E)-9-Hexadecenal, (Z)-5-Dodecen-1-ol (E)-9-Hexadecenol-ol, (Z)-5-Decenyl acetate, (E)-12-Pentadecenyl acetate, (Z)-5-Decen-1-ol, (Z)-10-Pentadecenal, (Z)-4-Tridecenyl acetate, (E,Z,Z)-4,6,10-Hexadecatrienyl acetate. (Z)-4-Tridecenal, (E, E,Z)-4,6,1-Hexadecatrienyl acetate, (Z)-4-Decenyl acetate, (Z)-8-Pentadecenyl acetate, (Z)-4-Decenai, (Z)-9-Pentadecenyl acetate, (Z)-3-Tetradecenyl acetate (E)-2-Octadecenal, (Z)-3-Tetradecen-1-ol (E)-2-Octadecenyl acetate, (Z)-3-Dodecenyl acetate, (Z)-7-Hexadecen-1-ol, (Z)-3-Dodecen-1-ol, (E)-7-Hexadecenyl acetate. (Z)-2-Tridecenyl acetate, (E, E,Z)-4,6,0-Hexadecatrien-ol, (Z)-12-Tetradecenyl acetate (E,E)-5,9-Octadecadien-1-ol, (Z)-11-Tridecenyl acetate, (Z)-2-Heptadecenal, (Z)-11-Tetradecenyl acetate, (Z,E)-3,13-Octadecadienyl acetate, (Z)-11-Tetradecenai, (Z,Z)-3,13-Octadecadienyl acetate, (Z)-10-Dodecen-1-ol, (Z,Z)-7,0-Hexadecadien-1-ol, (Z)-7-Undecenyl acetate, (Z)-5-Hexadecen-1-ol, (Z)-5-Decenal, (Z)-12-Pentadecenyl acetate, (Z)-11-Tetradecen-1-ol, (E,Z)-3,13-Octadecadienal, (E,Z,Z)-4,7,10-Tridecatrienyl acetate, (E, E)-4,8-Heptadecadienyi acetate, (E,Z)-9,11-Tetradecadienyl acetate, (E,Z)-8,10-Tetradecadienyl acetate, (E,Z)-8,10-Tetradecadienal, (E,Z)-8,10-Dodecadienyl acetate, (E,Z)-11,13-Hexadecadienyl acetate, (E,Z)-8,10-Dodecadienal, (E,Z)-11,3-Hexadecadienai, (E,Z)-8,10-Dodecadien-1-ol, (E,Z)-11,3-Hexadecadien-1-ol, (E,Z)-7,9-Dodecadienyl acetate, (E,Z)-10,12-Hexadecadien-1-ol, (E,Z)-7,9-Dodecadienal, (E,Z)-10,12-Hexadecadienyl acetate, (E,Z)-5,9-Tridecadienyl acetate, (Z)-9-Heptadecenal, (E,Z)-5,7-Dodecadienyl acetate, (E,Z)-8,11-Hexadecadienal, (E,Z)-5,7-Dodecadienal, (E, E)-9,11-Hexadecadienal, (E,Z)-4,9-Tetradecadienyi acetate, (Z,Z)-13,15-Octadecadienal, (E,Z)-4,9-Tetradecadienal, (Z,Z,Z)-3,6,9-Octadecatrienyl acetate, (E,Z)-4,7-Tridecadienyl acetate, (E)-8-Heptadecen-1-ol, (E,Z)-4,10-Tetradecadienyl acetate, (E,E,E)-9,2,5-Octadecatrien-1-ol, (E,Z)-3,8-Tetradecadienyl acetate, (E,E)-11,14-Octadecadienal, (E,Z)-3,5-Tetradecadienyl acetate, (Z,Z)-9,12-Octadecadienyl acetate, (E,Z)-3,5-Dodecadienyi acetate, (Z,E)-7,11-Hexadecadien-1-ol, (E,Z)-2,4-Decadienal, (E,Z)-8,10-Pentadecadien-1-ol, (E,Z)-7,9-Dodecadien-1-ol, (E,E)-10,12-Hexadecadienai 1, (E,Z)-5,7-Dodecadien-1-ol, (Z,Z)-8,10-Hexadecadieny acetate, (E,Z)-3,7-Tetradecadienyl acetate, (Z,Z)-11,13-Octadecadienal, (E,E,E)-10,12,14-Hexadecatrienyl, (E,E)-9,11-Tetradecadienyl acetate, (E,E)-8,10-Dodecadienyl acetate, (E,E)-1,13-Hexadecadienyl acetate, (E,E)-7,9-Dodecadienyl acetate, (E, E)-10,12-Hexadecadienyl acetate, (E,E)-5,8-Tetradecadienal, (Z,Z,Z)-9,12,15-Octadecatrienyi acetate, (E,E)-5,7-Dodecadienyl acetate. (Z,Z)-7,11-Hexadecadienal, (E,E)-5,7-Dodecadien-1-ol, (Z,Z)-7,1-Hexadecadienyl acetate, (E,E)-4,10-Dodecadienyi acetate, (Z,Z)-7,1-Hexadecadien-1-ol, (E,E)-3,5-Tetradecadienyl acetate, (E,E)-9,12-Octadecadien-1-ol, (E,E)-3,5-Decadienyl acetate, (Z,E)-8,10-Pentadecadienyl acetate, (E, E,Z)-10,12,14-Hexadecatrienyl, (E, E)-9,2-Tetradecadienyl acetate, (E, E)-8,10-Tetradecadienyi acetate, (E, E)-8,10-Tetradecadienal, (E, E)-8,1 Q-Dodeeadien-1-ol, (E,E)-11,13-Hexadecadien-1-ol, (E, E)-8, 0-Dodecadienal, (E,E)-11,13-Hexadecadienal, (E, E)-2,4-Tetradecadienal, (E,E)-5,9-Octadecadienyl acetate, (E, E)-2,4-Decadienal, (E, E)-8,10-Pentadecadienyl acetate. (E)-S-Tridecenyl acetate, (E,E,Z)-4,6. 10-Hexadecatrienyl acetate, (E)-S-Tetradecenal. (E)-9-Octadecen-1-ol 1, (E)-S-Tetradecen-1-ol, (Z)-2-Octadecenyl acetate, (E)-S-Dodecenyl acetate, (E)-S-Hexadecenyl acetate, (E)-S-Decenyl acetate, (Z)-10-Pentadecenyl acetate, (E)-I O-Tetradecenyl acetate, (Z,E)-2,13-Octadecadienyl acetate, (E)-I O-Dodecenyl acetate, (E,Z)-6,11-Hexadecadienyl acetate. (E)-I O-Dodecenal, (E,Z)-6,11-Hexadecadienal. (E)-9-Tridecenyl acetate acetate, (E)-9-Tetradecen-1-ol, (Z)-13-Octadecenal, (E)-9-Dodecenai, (Z)-14-Hexadecenyl acetate, (E)-9-Dodecen-1-ol, (Z)-12-Hexadecenal, (E)-9-Tetradecenyl acetate, (E)-14-Octadecenal, (E)-9-Dodecenyl acetate, (E)-14-Hexadecenal, (E)-8-Tridecenyl acetate, (E)-8-Tetradecenyl acetate, (E)-13-Octadecenyl acetate, (E)-8-Dodecenyl acetate, (Z)-11-Hexadecen-1-ol, (E)-8-Dodecenal, (Z)-11-Hexadecenyl acetate, (E)-8-Dodecen-1-ol, (E)-11-Hexadecenal, (E)-8-Decen-1-ol, (Z,Z)-6,9-Pentadecadienal, (E)-7-Tetradecenyl acetate, (E)-11-Octadecenal, (E)-7-Tetradecen-1-ol, (E)-11-Octadecen-1-ol, (E)-7-Dodecenyl acetate, (E)-10-Hexadecenal, (E)-7-Dodecenal, (Z)-10-Hexadecenyl acetate, (E)-7-Dodecen-1-ol, (E)-10-Hexadecen-1-ol, (E)-7-Decenyl acetate, (Z,Z)-8,9-Pentadecadien-1-ol, (E)-6-Tridecenyi acetate, (E, E,Z)-4,8,1-Hexadecatrienal, (E)-6-Tetradecenyl acetate, (Z)-9-Octadeceny acetate. (E)-6-Dodecenal, (Z)-9-Hexadecenal, (E)-6-Dodecen-1-ol, (Z)-9-Hexadecen-1-ol, (E)-5-Dodecen-1-ol, (Z)-7-Hexadecenal, (E)-5-Decen-1-ol, (E)-9-Pentadecenyl acetate, (E)-5-Tetradecenyl acetate, (Z)-2-Octadecenal, (E)-4-Tridecenyl acetate, (E,Z,Z)-4,6,10-Hexadecatrien-1-ol, (E)-4-Dodecenyl acetate, (Z)-7-Hexadecenyi acetate, (E)-4-Decenyl acetate, (Z)-8-Pentadecen-1-ol, (E)-3-Tetradecenyl acetate, (Z,Z)-8,11-Heptadecadienyi acetate, (E)-3-Tetradecen-1-ol, (Z,Z)-8,10-Heptadecadien-1-ol, (E)-3-Dodecenyl acetate, (E)-7-Hexadecenal, (E)-2-Undecenyi acetate, (Z)-3-Hexadecenyi acetate, (E)-2-Undecenal, (E)-5-Hexadecen-1-ol, (E)-2-Tridecenyl acetate, (Z,E)-1,14-Hexadecadienyl acetate, (E)-2-Dodecenal, (E)-7-Hexadecen-1-ol, (E)-12-Tetradecenyl acetate, (Z,Z)-3,13-Octadecadienai, (E)-11-Tetradecenyl acetate, (E, E)-3,13-Octadecadienyl acetate, (E)-10-Dodecen-1-ol, (E,Z)-4,6-Hexadecadienal, (E)-1-Tetradecen-1-ol, (Z,Z)-2,13-Octadecadienyl acetate, (E)-11-Tridecenyl acetate, (E)-2-Heptadecenal, (E)-11-Tetradecenal, (E,Z)-3,13-Octadecadienyl acetate, (E, E)-8,10-Tetradecadien-1-ol, or any combination thereof.

In some embodiments, the semiochemical(s) comprises (Z, Z)-7, 11-hexadecadien-1-yl acetate and (Z, E)-7, 11-hexadecadien-1-yl acetate for Pink Bollworm; Z 9-Tetradecenyl acetate, Z7-Dodecenyl acetate and Z11-Hexadecenyl acetate for Fall armyworm; Methyl eugenol; Methyl eugenol for fruit fly and Culure for melon fly; (E,E)-8,10-Dodecadien-1-ol for Codling Moth, Z-11-Hexadecenal and Z-9-Hexadecenal for Helico, for stink bug, Yellow stem borer, and wherein the semiochemical(s) are used individually or in the form of blends.

In some embodiments, the emulsion is an oil-in-water emulsion system which can be easily dispersible in water.

In some embodiments, the diluent comprises paraffin oil, soybean oil, cotton seed oil, olive oil, jojoba oil, sunflower oil, corn oil, peanut oil, sesame oil, castor oil, medium chain triglycerides, and isopropyl palmitate, or any combination thereof.

In some embodiments, the adhesion promoter and rheology modifying agent comprises poly vinyl pyrrolidone, PVA solution, or a combination thereof. In some embodiments, the adhesion promoting agent comprises poly vinyl pyrrolidone, or poly vinyl alcohol solution, or a combination thereof. In some embodiments, the stabilizer comprises ethylene glycol, diethylene glycol, propylene glycol, or glycerol, or any combination thereof.

In some embodiments, the preservative comprises methyl paraben, propyl paraben, sodium benzoate and potassium sorbate, or any combination thereof.

In some embodiments, the UV screening agent comprises activated charcoal, carbon powder or carbon HBET, or any combination thereof.

In some embodiments, the mesoporous material, such as carbon HBET, mesoporous silica, or a combination thereof, is used for control release matrix material. In some embodiments, the mesoporous material contributes to the controlled release of the semiochemical by adsorbing the semiochemical on its surface for prolonged release and thereby more efficient moth catch, as compared to conventionally used charcoal. In some embodiments, the semi-solid composition comprises a dispersed phase and dispersion medium which can be better described as given below:
(a) Dispersed phase comprising a semiochemical(s) in an amount in the range of 0.5 to 20 w/w %; the wax carrier is in an amount in the range of 0.5 to 60 w/w %; diluent in the range of about 0.5 to 20 w/w %; antioxidant in the range of about 0.01 to 6 w/w %; lubricant or texture modifier in the range of about 0.5 to 10 w/w % of the total composition;
(b) Dispersion medium comprising emulsifier in an amount in the range of 0.1 w/w % to 50 w/w % by of the total amount of the composition along with additive; and. the additive comprising
   I. stabilizer in an amount in the range of 0.5 w/w % to 10 w/w % of the total amount of the composition;
   I. preservative in an amount in the range of about 0.01 to 0.5 w/w % of the total amount of the composition; and
   III. film forming agent in an amount in the range of about 0.1 to 7.5 w/w % of the total amount of the composition
   IV. Carbon HBET and mesoporous silica in 0.1 to 10 w/w % of the total amount of the composition.

In some embodiments, the formulation may be applied as Controlled Release Enhanced Mating Interruption Technology application. In some embodiments, the controlled release semi-solid composition (e.g., a paste) comprises a base matrix formulation of biologically inert materials used to control the release of semiochemicals and/or odours with or without pesticides. In some embodiments, the controlled release paste/emulsion can comprise a variety of semiochemicals (e.g., lures) and the composition releases semiochemicals at effective pest suppression levels for a time interval ranging from about 6 weeks to about 15 weeks (e.g., about 8 to 12 weeks).

In some embodiments, the semiochemical composition described herein can be easily diluted and has tunable consistency and viscosity. In some embodiments, the semiochemical composition can be tuned to exhibit a wide range of viscosities and thereby allow for a variety of application methods, (e.g., applicator sprays, aerial applicator sprays, caulking gun type tubes, etc.). In some embodiments, the semiochemical composition can be applied mechanically over multiple dispersing points and thereby increase productivity of application. In some embodiments, the semiochemical composition can have low viscosity and be highly adaptable, allowing for an easy transition from small-scale manual applications to large-scale mechanical applications.

In some embodiments, the semiochemical composition comprises semiochemical(s) entrapped within a wax and displays steady, controlled, and sustained release of the semiochemical for a longer period of time (e.g., at least 8 weeks). In some embodiments, the wax helps the delivery of the semiochemical(s) and is advantageous for camouflaging the treated area with semiochemicals to attracting adult insects or modify insect natural behaviour thus to achieve mating disruption. In some embodiments, the semiochemical composition is eco-friendly, cost effective, physiochemically stable, exhibits rainfastness, for pest management delivery system, and is used by direct application on plant surfaces and also stored at room temperature with caped tube for longer time without any compromise in quality.

In some embodiments, the semiochemical composition may comprise customary auxiliary agrochemicals depending upon particular application form and active semiochemical(s) substance respectively. Auxiliaries may include water or solvent, solid carriers, dispersant, emulsifiers, solubilizers, thickeners, protective colloids, surfactants, adhesion promoting agents, anti-freezing agents, anti-foaming agents, colorants, bactericides, antimicrobial agent, and the like.

In another embodiment, the composition described herein comprises microcapsules (e.g., microcapsules with core-shell structure) in wax semiochemical(s), wherein the microcapsules comprises aminoplast resins, poly urea and ethyl cellulose as controlled release matrix polymers.

In some embodiments, the semi-solid composition has a pH in the range of about 4.5 to about 7 (e.g., about 5 to 6.5). In some embodiments, the semi-solid composition is dispersible in water.

In some embodiments, the semi-solid compositions exhibit rainfastness and adheres on the plant surface for longer time even during rain, as determined by ASTM STP 1268 procedure. In an embodiment of the present disclosure, the semi-solid composition exhibits chemical and physical stability at 0° C. to 54° C. temperature with controlled release of semiochemical(s) over an extended period of at least four weeks (e.g., at least 6 weeks or at least 8 weeks).

In another embodiment of the present disclosure, semiochemical(s) present in the semi-solid composition exhibits controlled release and triggers behavioural response in insect species. In some embodiments, the release rate of semiochemical(s) from the composition described herein is in the range of 1 to 20 milligrams per gram per day and can be modulated with change of excipients concentration.

In some embodiments, the semiochemical composition further comprises a humectant or a stabilizer. In some embodiments, the humectants/stabilizer is propylene glycol. In some embodiments, the oropylene glycol as humectants/stabilizer prevents the composition from drying out and further aids in preserving the texture. In some embodiments, the semiochemical composition further comprises a rheology modifier. In some embodiments, the rheology modifier is used to provide flow of the composition from the tube without being stingy which may comprise sorbitol, propylene glycol, glycerine, magnesium stearate, carbon HBET, or any combination thereof.

In an embodiment of the present disclosure, the semi-solid composition is used alone. In another embodiment of the present disclosure, the semi-solid composition is used in combination with insecticides or agricultural adjuvants or colouring agent for its application.

In some embodiments, the semi-solid composition of the present disclosure may be used in a form comprising cream, paste, gel, or glue.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

### Methods of Preparation

In another aspect there is provided a method for preparing a semi-solid emulsion composition. In some embodiments, the method comprises: (a) preparing a dispersed phase; (b) preparing a dispersion medium; and (c) mixing the dispersed phase and the dispersion medium.

In some embodiments, the step (a) preparation of the dispersed phase comprises: (a-i) mixing wax and diluent oil at melting temperature of wax-oil blend to obtain molten waxy liquid; (a-ii) dispersing a semiochemical(s) which is alone or adsorbed on mesoporous silica and carbon HBET together with a diluent, an antioxidant, and a texture modifier in the molten waxy liquid under stirring.

In some embodiments, the step (b) preparation of the dispersed phase comprises preparing an aqueous phase by mixing aqueous polymer solution and emulsifier under stirring at same temperature to the melting temperature of wax-oil blend.

In some embodiments, the step (c) comprises mixing the aqueous dispersion medium obtained in step (b) with the dispersed phase obtained in step (a) at about 3000 rpm using bottom homogenizer.

In some embodiments, the method further comprises adding humectant/stabilizer to the mixture of step (c) along with preservative at a temperature in the range of 60° C. to 65° C. to obtain the semi-solid emulsion composition.

In some embodiments, provided herein is a method for preparing a semi-solid emulsion composition which comprises dispersed phase and dispersion media, the method comprising the following steps:
(a) Preparation of dispersed phase:
   i. wax and diluent oil were mixed together at melting temperature of wax—oil blend to obtain molten waxy liquid
   ii. Semiochemical/s alone or adsorbed on mesoporous silica and carbon HBET, diluent, antioxidant, and texture modifier were dispersed in the molten waxy liquid under stirring.
(b) Preparation of dispersion medium:
   Separate aqueous phase prepared by mixing aqueous polymer solution and emulsifier under stirring at same temperature to the melting temperature of wax-oil blend.
(c) The aqueous phase obtained in step (b) added to the mixture obtained in (a) and mixed at about 3000 rpm using bottom homogeniser; and
   (d) Finally humectant/stabilizer was added along with preservative at a temperature in the range of 60° C. to 65° C. to obtain the semi-solid emulsion composition.

In some embodiments, provided herein is a method for preparing a semi-solid emulsion composition, the method comprising:
(a) preparing a dispersed phase, comprising
   (a-1) mixing a wax, about 10% of a diluent, and saturated or unsaturated fatty acid and/or alcohol at the melting temperature of mixture to obtain a molten waxy liquid; and
   (a-2) dispersing a semiochemical which is alone, adsorbed on mesoporous silica and carbon HBET, or encapsulated along with a diluent, an antioxidant, and a texture modifier in the molten waxy liquid under stirring;
(b) preparing a dispersion medium, comprising
   preparing an aqueous phase by mixing aqueous adhesion promoter polymer solution and emulsifier under stirring at same temperature to the melting temperature of wax blend; and
(c) mixing the aqueous phase obtained in step (b) with the mixture obtained in (a) using bottom or laboratory homogenizer to obtain the semiochemical composition.

In some embodiments, the semiochemical used herein comprises PBW, OFM, TML, FCM, TUTA, RHY, ME, CL, Lobesia, BFSB, Helico, DBM, Carob moth, Codling moth, YSB, NOW, ESB, Verbenone, Spodo, or any combination thereof.

### Uses

In some embodiments, provided herein is a method of use the semi-solid composition described herein. In some embodiments, provided herein is a method of applying a semiochemical composition provided herein in the field at or near a plant in the field to decrease the population of pests affecting plants in the field. In some embodiments, provided herein is a method of controlling pests affecting plants in a field (e.g., killing pests, reducing the numbers of pests, slowing down the spread of pests, or reducing harms caused by a pest). In some embodiments, the method comprises applying a semiochemical composition described herein in the field at or near a plant in the field to attract male insect pests and cause the male insect pests in the field to die without producing offspring. In some embodiments, the method comprises attracting male insect pests and then trap and/or kill the pests. In some embodiments, the method comprises attracting male insects to reduce the likelihood that the male insect pests find female insect pests for mating in the field. In some embodiments, the method may comprise applying the composition over multiple applications at discrete point sources, wherein the composition at each discrete point source competitively attracts male insect pests over female insect pests. In some embodiments, the composition, at each application, comprises a unit dose between 1 mg to about 500 mg (e.g., about 5 mg to about 20 mg) of at least one semiochemical. In some embodiments, the semiochemical composition can be applied in a field in India, China, Africa, Mexico or the United State.

In some embodiments, the method provided herein decreases (i) the average number of adult insect pests over the multiple applications; and/or (ii) the overall damage to the plants in the field, as compared to plants in a field in which the semiochemical composition has not been applied.

In some embodiments, the semi-solid composition of the present disclosure can be used to control undesired insect infestation, such as Lepidoptera, Hemiptera, Coleoptera, Diptera, Thysanoptera, Hymenoptera (for example codling moth), which are responsible for substantial losses of crops. In some embodiments, the insects are controlled by means of attraction and kill technique, confusion and disorientation or mating disruption. In some embodiments, the semiochemical(s) substance may be targeted for a single kind of pest or may be targeted for at least two kinds of insect pests. The semiochemical(s) substance may be present in pre-mix solution of wax-based paste composition either in dissolved, dispersed, or solid form.

In some embodiments, the composition described herein can be used to control a pest, wherein the pest may be selected from the group consisting of Pectinophora gossipiella; Spodoptera frugiperda; Leucinodes orbonalis; Plutella xylostella; Lobesia botrana; Cydia pomonella; Grapholita molesta; Anarsia lineatella; Thaumatotibia leucotreta; Tuta absoluta; Ectomyelois ceratoniae; Phyllocnistis citrella; Helicoverpa zea; Scirpophaga incertulas; Chilo infuscatellus; Chilo sacchariphagus indicus; Amyelois transitella; or Planococcus ficus, or any combination thereof. In some embodiments, the pest may be selected from the group consisting of Pink bollworm; Fall army worm; Brinjal Fruit and Shoot Borer, Diamond backmoth; Grapevine moth; Codling moth; Oriental Fruit moth; Peach Twig Borer; False Codling Moth; Tomato Leaf Miner: Carob Moth; Citrus leaf miner, Corn Ear Worm; Rice Yellow Stem Borer, Sugarcane Early Shoot Borer, Sugarcane Internode borer; Navel orangeworm; or Vine mealybug, or any combination thereof.

### Technical Advances and Economical Significance

The present disclosure described herein above has several technical advantages including, but not limited to a semi solid composition comprises the semiochemical(s) and/or attractant along with mesoporous materials
1. the composition is water dispersible, environmentally friendly can be applied manually or using any mechanical devices, drones and airplanes to conveniently adopt and incorporate pest management program in wide areas. It has low cost, and works for the entire duration of the crop season.
2 the composition possesses physio-chemical properties of the delivery vehicle with hydrophobicity, water repellence, rain fastness in order to adhere to plant or any solid substrate, liner release of semiochemical(s)s and are resistant to environmental conditions such as, temperature, rain, humidity and UV rays.
3. use of renewable food grade biodegradable excipients with low semiochemical per acre with superior pest control levels so that the technology can be adopted for large scale operation in par with conventional insecticides; and

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

A liquid sprayable emulsion and a semi-solid emulsion with a paste like consistency including the applicant's semiochemical(s) can be developed by optimizing the concentration of each ingredient proposed according to organoleptic acceptance and stability criteria.

The semi-solid composition of the present disclosure is non-phytotoxic, rain fast, releases semiochemical(s) in a controlled linear release close to zero order for long time, stable under various environmental conditions, dose dependent release to cover different semiochemical(s) with different crop cycles, uses renewable source of raw materials, and is economical and biodegradable. The preparation and use of natural wax derivatives for controlled and prolonged emission of semiochemical(s), based on the modification of the physicochemical properties of molecules may be able to satisfy the high demand for alternatives insect control in such a way that they provide an emission kinetics adapted to the specific properties of each semiochemical(s). Thus, such semi-solid composition of the present disclosure offers an advanced slow-release matrix that suits for all sorts of agricultural crops viz., vegetables, fruits, nuts, row crops etc.

The semi-solid composition of the present disclosure with semiochemical(s) will be useful for insect pest management either as mass trapping or attract and kill or mating disruption that exhibits delayed release plot form technology. The semi-solid compositions of the present disclosure are target specific insect which significantly controls the economically important injurious insect pests like Tuta absoluta in tomato, Plutella xylostella in cabbage, cauliflower and broccoli, Leucinodes orbonalis in brinjal, Pectinophora gossypiella in cotton, Spodoptera frugiperda in Maize, Helicoverpa armigera in chilli, cotton, capsicum, maize and the like, Lobesia botrana in grapes, Cydia poronella in apple, Phyllocnistis citrella in citrus crops, Arvelois transitella in almond and pistachios, Bactrocera dorasalis in fruit crops, Bactrocera cucurbitae in cucurbits and the like.

### ENUMERATED EMBODIMENTS

The following enumerated embodiments are representative of some aspects of the invention.

Embodiment 1. A semiochemical(s) based semi-solid emulsion composition comprising a dispersed phase and dispersion medium that is characterised as—
(a) Dispersed phase in an amount of about 50 w/w % of the total composition which comprises semiochemical(s), wax, mesoporous material, long chain saturated or unsaturated fatty acid or/and alcohols, diluent, and antioxidant,
(b) Mesoporous material in an amount of up to 10 w/w % of the dispersed phase
(c) Long chain saturated or unsaturated fatty acid or alcohols in an amount up to 10 w/w % of dispersed phase
(d) Dispersion medium comprises an amount about 50 w/w % of the total amount of the composition;
(e) additives comprises in an amount of about 2 to 30 w/w % of the total amount of the dispersion medium;
wherein, the said composition exhibits rainfastness, non-phytotoxicity to plant surface, controlled release of semiochemical(s) for minimum of about twelve weeks is stable under drastic environmental conditions, suitable for mating disruption, attract and kill, mass trapping of the insect pests.

Embodiment 2 The semi-solid composition of embodiment 1, wherein
(a) Dispersed phase comprises a semiochemical(s) and/or attractant either alone or encapsulated in polymer matrix or both or premixed or adsorbed with mesoporous material in an amount of about 0.1 to 20 w/w % or combination of thereof; the wax carrier is in an amount of about 0.1 to 50 w/w %; saturated or unsaturated long chain fatty acid/alcohol of about 0.1 to 20 w/w %; diluent of about 0.1 to 15 w/w %; antioxidant of about 0.01 to 6 w/w %; lubricant/texture modifier of about 0.1 to 10 w/w % of the total composition;
(b) Dispersion medium comprises emulsifier in an amount of about 0.1 w/w % to 20 w/w % by of the total amount of dispersion medium; along with additives and;
(c) Additives comprises
   I. Film forming or adhesion promoting agent in an amount in the range of about 0.1 to 7.5 w/w % of the total amount of the composition;
   II. Preservative in an amount of about 0.01 to 0.5 w/w % of the total amount of the composition;
   III. Stabilizer in an amount of about 0.1 to 10 w/w % of the total amount of the dispersion medium;
   IV. UV screening agent and controlled release materials such as carbon HBET 0.1 to 10 w/w % of the total amount of the composition and,
   V. Rheology modifier such as hydrophilic silica of about 0.1 to 10 w/w % of the total amount of the composition;
wherein the additives are selected from the group comprising stabilizer or humectant, preservative, rheology modifier, adhesion promoter or film former, UV screening agents or mixtures thereof.

Embodiment 3. The semi-solid composition in embodiment 1 wherein the semiochemical/s is selected from the group consisting of pheromones, allomone/s, kairomone/s, synomone and combinations thereof.

Embodiment 4. The semi-solid composition of embodiment 2, wherein the mesoporuos material used for premix or adsorption of semiochemical(s) is Carbon HBET optionally used in combination with mesoporous silica in the ratio with semiochemical(s) from 1:10 to 10:1 for prolonged release of semiochemical(s).

Embodiment 5. The semi-solid composition of embodiment 2, wherein the mesoporous material nanostructured materials or carbon HBET have surface area of about 2000 m²/g measured using nitrogen adsorption method.

Embodiment 6. The semi-solid composition of embodiment 1, wherein wax carrier is selected from the group consisting of natural wax, synthetic wax and combinations thereof.

Embodiment 7. The semi-solid composition of embodiment 2, wherein the semiochemical encapsulated in natural or synthetic polymer matrix viz., gelatine, alginates, chitin, aminoplast resin or the alkoxy cellulose or its derivatives or poly urea derivatives or methacrylate coated particles or embedded in wax particles;

Embodiment 8. The semi-solid composition of embodiment 1, wherein the emulsion is an oil-in-water emulsion system.

Embodiment 9. The semi-solid composition of embodiment 2, wherein the insect semio-chemical/s are selected from the group consisting of the active blend of (Z, Z)-7,11-hexadecadien-1-yl acetate and (Z, E)-7,11-hexadecadien-1-yl acetate; the active blend of Z 9-Tetradecenyl acetate, Z7-Dodecenyl acetate and Z11-Hexadecenyl acetate; the active blend of E-11-hexadecen-1-yl acetate and (E)-11-hexadecen-1-ol; the active blend of 3E,8Z,11Z-Tetradecatrienyl acetate and 3E,8Z-Tetradecadienyl acetate; the active, (Z,Z,E)-7,11,13-Hexadeca trien-1-al; the active blend of Z-11-Hexadecenal, Z-11-Hexadecenyl-1-acetate and Z-11-Hexadecenol; the active blend of Z-11-Hexadecenal and Z-9-Hexadecenal; the active blend of Z-11-Hexadecenal and Z-9-Hexadecenal; the active blend of (Z,E)-9,11-Tetradecadienyl acetate and Z9,E-12-Tetradecadienyl acetate; the active blend of Cis-3-Hexenyl acetate and 2E-Hexen-1-ol; the active blend of Z-11-Hexadecenyl-1-acetate and Z-11-Hexadecenol; the active of Z-11-Hexadecenol; the active of (7Z,9E)-Dodeca-7,9,1l-trien-1-yl formate; 11Z,13Z-Hexadeca dienal; the active blend of 4 methyl 5 nonanol and 4 methyl 5 nonanone; the active of Ethyl-4-Methyl octanoate; the active of Methyl eugenol; the active blend of Methyl eugenol and Cuelure; the active of (E,E)-8,10-Dodecadien-1-ol; the active blend of (Z)-8-Dodecen-1-yl acetate, (E)-8-Dodecen-1-yl-acetate and (Z)-8-Dodecen-1-ol; the active, (1R)-cis-4,6,6-Trimethylbicyclo [3.1.1]hept-3-en-2-one; the active trans-3,7-Dimethyl-2,6-octadien-1-ol & cis-3,7-Dimethyl-2,6-octadien-1-ol; the blend of Z-13-Octadecynyl acetate and Z-13-Octadecenol; the blend of (E,E)-10,12-hexadecadienal, (E,E)-10,12-hexadecadienol and E-10-hexadecenal; the blend of Z,E-9,12-Tetradecadien-1-yl-Acetate and Z-9 Tetradecenol; the blend of (Z)-8-Dodecen-1-yl acetate and (E)-8-Dodecen-1-yl-acetate; the active, (7E,9Z) dodeca-7,9-dien-1-yl acetate, and the active 4-vinyl Anisole; Methyl Isonicotinate; Mono terpenes, and Terpene alcohols; and wherein the semio-chemical/s are used individually or in the form of blends.

Embodiment 10. The semi-solid composition in embodiment 2, wherein the semio-chemical/s is selected from the group consisting of (Z, Z)-7,11-hexadecadien-1-yl acetate and (Z, E)-7,11-hexadecadien-1-yl acetate for Pink Bollworm; Z 9-Tetradecenyl acetate, Z7-Dodecenyl acetate and Z11-Hexadecenyl acetate for Fall armyworm; Methyl eugenol; Methyl eugenol for fruit fly and Culure for melon fly; (E,E)-8,10-Dodecadien-1-ol for Codling Moth, Z-11-Hexadecenal and Z-9-Hexadecenal for Helico, for stink bug and Yellow stem borer, and wherein the semio-chemical/s are used individually or in the form of blends.

Embodiment 11. The semi-solid composition in embodiment 2, wherein the synthetic wax is selected from the group consisting of microcrystalline wax, ozokerite, ceresin, montane wax, paraffin and combinations thereof.

Embodiment 12. The semi-solid composition in embodiment 2, wherein the natural wax is selected from the group consisting of rice bran wax, sunflower wax, bees wax, candelilla wax, carnauba wax, Chinese insect wax, esparto wax, Japan wax, spermaceti wax, lanolin wax and combinations thereof.

Embodiment 13. The semi-solid composition in embodiment 2, wherein the long chain saturated fatty acids/alcohols is selected from the group consisting of cetostearyl alcohol, cetyl alcohol, stearyl alcohol, stearic acid, montanic acid, oleic acid, polyhydroxy alcohol or combination thereof.

Embodiment 14. The semi-solid composition in embodiment 2, wherein the emulsifier is selected from the group consisting of phospholipid, Polyoxyethylene Sorbitan Monolaurate, Sorbitan Monostearate, sorbitan monoleate, Polyoxyethylene Lauryl Ether, Polyoxyethylene glycol octadecyl ether, Polyoxyethylene Sorbitan Monolaurate, polyoxyethylene sorbitan monooleate, and combinations thereof.

Embodiment 15. The semi-solid composition in embodiment 2, wherein the diluent is selected from either paraffin oil, soybean oil, cotton seed oil, olive oil, jojoba oil, sunflower oil, corn oil, peanut oil, sesame oil, castor oil, medium chain triglycerides, Isopropyl palmitate alone or combinations of thereof.

Embodiment 16 The semi-solid composition in embodiment 2, wherein the film forming or adhesion prompting agent is selected from poly vinyl pyrrolidone, Poly vinyl alcohol solution or mixture of thereof preferably PVP.

Embodiment 17. The semi-solid composition in embodiment 2, wherein the stabiliser or humectant is selected from the group ethylene glycol, diethylene glycol, propylene glycol, glycerol either alone or mixture of thereof.

Embodiment 18. The semi-solid composition in embodiment 2, wherein the preservative is selected from methyl paraben, propyl paraben, sodium benzoate and potassium sorbat either alone or mixture of thereof.

Embodiment 19. The semi-solid composition in embodiment 2, wherein the antioxidants is selected from BHT, BHA and tocopherol.

Embodiment 20. The semi-solid composition in embodiment 2, wherein the lubricants/texture modifier selected from group of metallic stearates like magnesium stearate, zinc stearate, calcium stearate most preferably magnesium stearate.

Embodiment 21. The semi-solid composition in embodiment 2, wherein the UV protectants selected from group of activated charcoal, carbon powder or carbon HBET.

Embodiment 22. A method for preparing a semi-solid emulsion composition, the method comprising the following steps:
(a) Preparation of dispersed phase:
   I. Wax, part of diluent and saturated or unsaturated fatty acid and/or alcohol were mixed together at melting temperature of blend to obtain molten waxy liquid.
   ii. Semiochemical(s) either alone or adsorbed on mesoporous silica and carbon HBET or encapsulated form along with diluent, antioxidant, and texture modifier were dispersed in the molten waxy liquid under stirring.
(b) Preparation of dispersion medium:
   Separate aqueous phase was prepared by mixing aqueous adhesion promoter polymer solution and emulsifier under stirring at same temperature to the melting temperature of wax blend.
(c) The aqueous phase obtained in step (b) added to the mixture obtained in (a) and mixed at about 2000 rpm using bottom or laboratory homogeniser; and
(d) Finally humectant/stabiliser along with preservative was added at a temperature in the range of 60° C. to 65° C. to obtain the semi-solid emulsion composition.
(e) pH of the resulting semisolid composition was adjusted to 5.5 to 6.5.

Embodiment 23. The semi-solid composition of embodiment 1, wherein the composition exhibits chemical and physical stability at least eight weeks at accelerated condition of 54° C. temperature, and two years at room temperature.

Embodiment 24. The semi-solid composition of embodiment 1, wherein the composition exhibits controlled release of semiochemical(s) in range of 1 to 20 milligrams per day per gram of semisolid composition under open field exposure with respect to the function of semiochemical characteristics, whereas the release rate can be modulated with respect to specific crop requirement.

Embodiment 25. The semi-solid composition of embodiment 1, wherein the composition is applied onto plant foliage, plant surface or any support system in agricultural field in need thereof.

Embodiment 26. The semi-solid composition of embodiment 1, wherein the semi-solid composition is optionally used alone or in combination with compatible insecticides or agricultural adjuvants or colouring agent for its application.

Embodiment 27. The semi-solid composition of embodiment 1, wherein the composition can prepared and utilized in a form of cream, paste, gel, and glue.

### EXAMPLES

The presently disclosed subject matter will be better understood by reference to the following Examples, which are provided as exemplary of the invention, and not by way of limitation.

### Example F-1: Field Studies

The semi-solid composition of the present disclosure controlled release paste technology along with PBW semiochemical(s) was applied in the form of dollops in five different cotton fields each in Maharashtra, Karnataka and Gujarat for disrupting the mating of pink bollworm, Pectinophora gossypiella successfully to an average of 93.94% respectively. This contributed to an average yield increase of 58% in Maharashtra, 44% in Karnataka and 41.4% in Gujarat over control. The percentage green boll damage was lesser in the controlled release paste (PBW) treated plots when compared to the farmer's practices adopted control plot. The percentage green boll damage was in the range of 5.14% to 17.1% and 14.0 to 24.29% in the treated and control plots, respectively.

The semi-solid composition of the present disclosure controlled release paste along with BFSB semiochemical(s) was applied in the form of dollops in different fields of brinjal in Karnataka and Maharashtra for disrupting the mating of Brinjal fruit and shoot borer, Leucinodes orbonalis by and 90.6% respectively. This contributed to an average yield increase of 8.5%. The percentage fruit damage was lesser in the controlled release paste (BFSB) treated plot when compared to the farmer's practices adopted control plot. The percentage fruit damage was in the range of 0.27% to 4% and 6.79% to 20% in the treated and control plots, respectively. The semi-solid formulation of the present disclosure controlled release paste along with TUTA semiochemical(s) was applied in the form of dollops in a tomato field in Kolar, Karnataka for disrupting the mating of Tomato Leaf Miner, Tuta absoluta by 97.8%. This contributed to a substantial yield increase of 45% over control. The fruit damage in treated plot was about 4%, whereas the fruit damage in control was about 38.6%.

The semi-solid composition of the present disclosure controlled release paste along with DBM semiochemical(s) was applied in the form of dollops in cauliflower fields in Maharashtra for disrupting the mating of diamondback moth, Plutella xylostella by 91.67% on an average. Similarly, treatment of controlled release technology (Helio) in chilli fields for the management of Helicoverpa armigera in Gujarat disrupted mating by 95.6%.

All these controlled release semi-solid compositions were found to be non-phytotoxic for selected crops under investigation. The rainfast nature of the composition was tested especially during rainy seasons in the states of Punjab, Gujarath, Maharashtra, Tamilnadu, Andhra Pradesh as well as Telangana regions and percent retention on the plant foliage was found satisfactory more than 80 percent and to meet the amount the active per hectare required to control the pest population during the season long crop cycle.

The release data of the semi-solid formulation of the present disclosure is provided in FIGS. 1 to 8.

Based on the agricultural field exposure data, the release profile of the semi-solid formulation of the present disclosure with respect to different active at the same level of loading are illustrated in FIGS. 1-8.

FIG. 1 illustrates the effect of active release on agricultural field exposure of Lobesia controlled release paste formulations prepared by using different types of waxes. It is seen from

FIG. 1 that at the same level of active loading, effect of wax change is minimal, and they don't have any effect on active release. The non-effectiveness of wax change is clearly concluded in the formulations prepared by using microcrystalline (MC) wax and rice brain wax exhibiting similar release pattern.

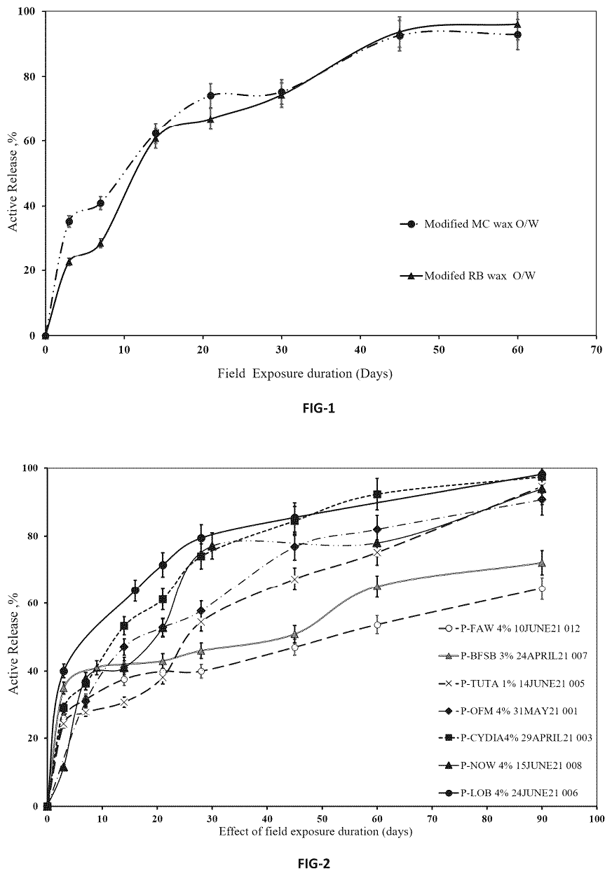

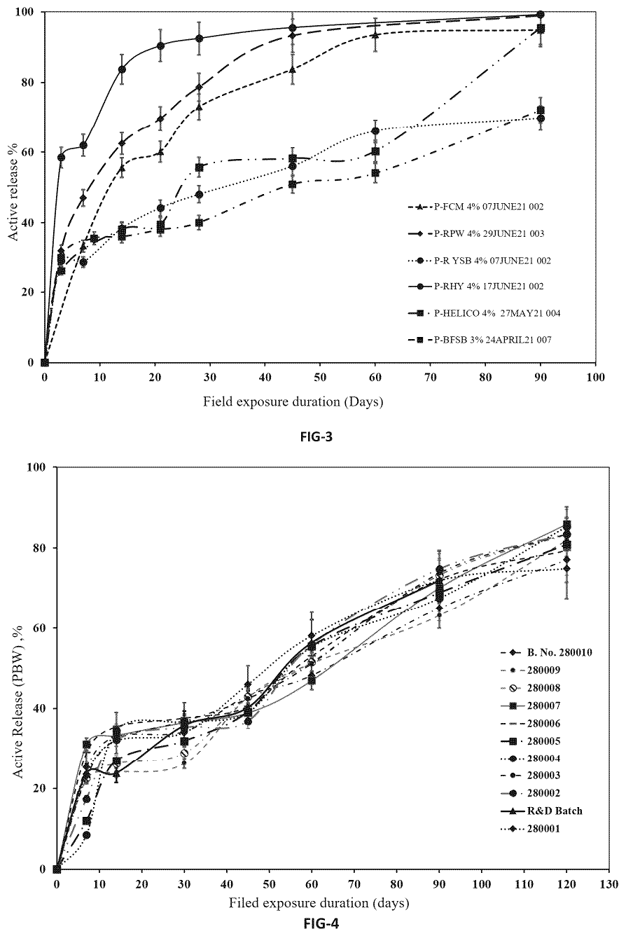

It is seen from FIGS. 2-3 that active release is sustained up to at least eight weeks, and which may be further extended (more than twelve weeks or three months) due to higher retention of the actives within the formulation, which will be released during further time period.

FIG. 4 illustrates the effect of open agricultural field exposure on release of different Scale-up batches of controlled release paste manufactured in commercial scale equipment's for PBW active. It is seen from FIG. 4 that the sustained release duration from PBW formulation is at least three to four months.

FIG. 5: illustrates the effect of field exposure on the release profile in controlled release paste formulations prepared for different semiochemical(s) containing different functional groups with different carbon chain length between C8 to C16 along with functional groups. The formulation characteristics are modulated based on the different vapour pressure and escape rates of different actives containing functional groups are sufficiently demonstrated with controlled release mechanism.

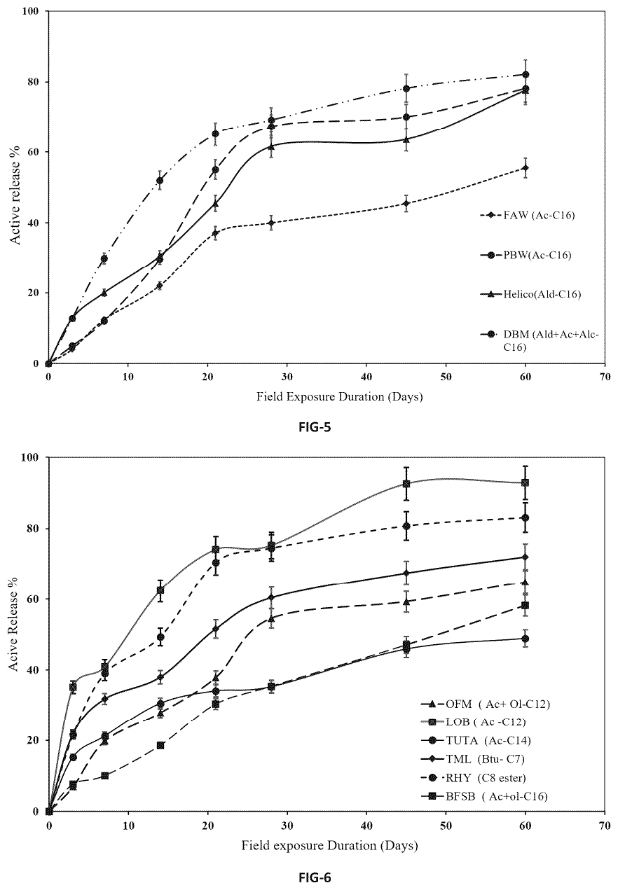

FIG. 6: illustrates the effect of field exposure on the release profile in controlled release paste formulations prepared for different semiochemicals containing different functional groups with different carbon chain length between C8 to C16 along with functional groups. The formulation characteristics are modulated based on the different vapour pressure and escape rates of different actives containing functional groups are sufficiently demonstrated with controlled release mechanism.

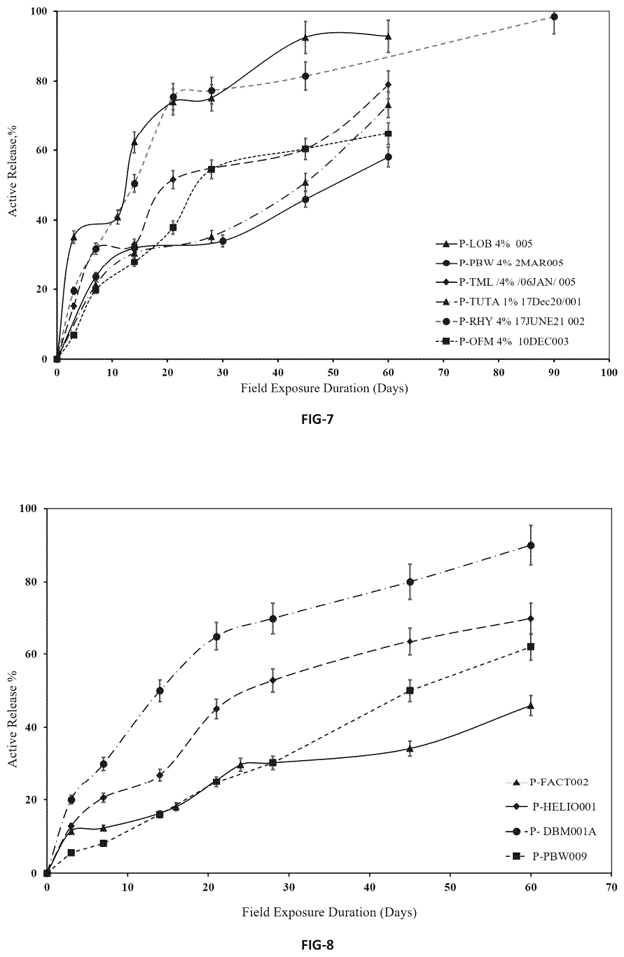

FIG. 7: illustrates the effect of field exposure on the release profile in controlled release paste for prepared by modified microcrystalline wax formulations. The release duration of OFM, LOBESIA, TUTA, TML, RHY and PBW sustain at least up to three months.

FIG. 8 illustrates the effect of field exposure on the release profile in controlled release paste formulations prepared by modified rice bran wax formulations with prolonged release of actives to suit the crop period to manage the pest control measures for at least two to three months. Examples of actives extensively studies are FAW, HELIO, PBW and DBM.

As indicated by the field studies and FIG. 1 to FIG. 8, the semi-solid composition of the present disclosure is non-phytotoxic, rainfast, releases semiochemical(s) in a controlled release close to zero or first order for season long up to 6 months stable under various environmental conditions, dose dependent release to cover different semiochemical(s)s with different crop cycles, uses renewable source of raw materials, and is economical and biodegradable.

As indicated by the field studies and FIG. 1 to FIG. 8, the preparation and use of natural wax derivatives for controlled and prolonged emission of semio-chemicals, based on the modification of the physicochemical properties of molecules may be able to satisfy the high demand for alternatives insect control in such a way that they provide an emission kinetics adapted to the specific properties of each semiochemical(s). Thus, such semi-solid composition of the present disclosure offers an advanced slow-release matrix that suits for all sorts of agricultural crops, such as vegetables, fruits, nuts, row crops etc.

As indicated by the field studies and FIG. 1 to FIG. 8, the semi-solid formulation of the present disclosure with semiochemical(s) are useful for insect pest management either as mass trapping or attract and kill or mating disruption that exhibits delayed release plaform technology. The semi-solid formulations of the present disclosure are target specific insect which significantly controls the economically important injurious insect pests like Tuta absoluta in tomato, Plutella xylostella in cabbage, cauliflower and broccoli, Leucinodes orbonalis in brinjal, Pectinophora gossypiella in cotton, Spodoptera frugiperda in Maize, Helicoverpa armigera in chilli, cotton, capsicum, maize and the like, Lobesia botrana in grapes, Cydia pomonella in apple, Phyllocnistis citrella in citrus crops, Amyelois transitella in almond and pistachios, Bactrocera dorasalis in fruit crops, Bactrocera cucurbitae in cucurbits and the like.

The semi-solid emulsion compositions provided herein are highly effective in achieving insect behavioral modification in insect pests for season long control achieved through controlled release pattern of semiochemical. The semi-solid composition is capable of gradually releasing a semiochemical(s) suitable for developing season long insect pest control solutions. The composition is amenable in various forms & nature. It can be easily dispensed and applied on a tree or a crop or any substrate available in the field for uniform distribution of the composition such that the release of semiochemical(s) is uniform across the applied area.

The semi-solid compositions of the present disclosure are capable of controlling insect/pests that are harmful to agrarian crops by means of attraction and kill technique, confusion and disorientation or mating disruption, wherein the composition resistant to high humid conditions and is highly rain fast.

### Example P-1: Preparation of Semi-Solid Composition with 2% AI—TUTA

A mixture of 26 g of microcrystalline wax, 5 g of soya bean oil and 6 g of Cetostearyl alcohol is charged in glass vessel, and heated at 80-85° C. in water bath, under stirring to obtain liquid wax. 2.9 g of Magnesium stearate is added in the same vessel under stirring at 700 rpm, and. Further a mixture of 2 g AI (TUTA), 5 g of Soybean oil, and 50 mg of BHT is adsorbed on to mesoporous silica and Carbon HBT combination and then added under stirring to the molten waxy liquid and kept under continuous stirring for about 10-15 minutes. Another solution called aqueous phase is prepared in a separate vessel by melting 4.46 g of span 60 and 5.55 g of tween 60 in 37 g of 4.5% polyvinyl alcohol solution. This aqueous phase is mixed in the molten wax under stirring at 85° C. and homogenise at 2000 rpm. After mixing, the resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5 using 10% HCl solution or ethanolamine solution.

### Example P-2: Preparation of Semi-Solid Composition with 4% AI—RHY

A mixture of 26 g of rice bran wax, 4 g of sunflower oil and 3 g Stearic acid melt together in a glass vessel equipped with suitable size propeller at about 85° C. and kept under stirring at 700 rpm to get a molten waxy liquid. 2.9 g of Magnesium stearate is added in the same vessel in the molten wax under stirring at 700 rpm. Further a mixture of 4 g AI (RHY), 5 g of sunflower oil, and 50 mg of BHT adsorbed on to mesoporous silica/Carbon HBT combination and then added under stirring to the molten waxy liquid and kept under continuous stirring for about 10-15 minutes. Another solution called aqueous phase is prepared in a separate vessel by melting 5.74 g of span 60 and 7.68 tween 60 in 35.51 g of 4.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C. 5 g of propylene glycol containing 120 mg of methyl paraben is added and further allowed to cool at room temperature. pH of the pasty material is adjusted in the range of 5.5 to 6.5 using 10% HCl or ethanolamine solution.

### Example P-3: Preparation of Semi-Solid Composition with 4% AI—RHY

26 g of microcrystalline wax, 6 g of bees wax, 2 g of peanut oil and 2 g of cetostearyl alcohol mixed together in a glass vessel equipped with suitable size propeller, and heated at about 85° C. and kept under stirring at 700 rpm. 2.9 g of Magnesium stearate is added in the same vessel under stirring at 700 rpm. Further a mixture of 4 g AI (RHY), 2 g of peanut oil, and 50 mg of BHT adsorbed on to mesoporous silica/Carbon HBT combination and then added under stirring to the molten waxy liquid and kept under continuous stirring for about 10-15 minutes. Another solution called aqueous phase is prepared in a separate vessel by melting 5.74 g of span 60 and 7.68 tween 60 in 35 g of 4.5% polyvinyl alcohol solution. This aqueous phase is mixed in the molten wax under stirring at 85° C. and homogenise at 2000 rpm using laboratory homogeniser. After mixing, mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5.

### Example P4: Preparation of Semi-Solid Composition with 4% AI—OFM

25 g of carnauba wax, 6 g of microcrystalline wax, 2 g of cetostearyl alcohol and 5 g of soybean oil mixed together in a glass vessel equipped with suitable size propeller and heated at about 85° C. and kept under stirring at 700 rpm. 2.9 g of Magnesium stearate is added in the same vessel under stirring at 700 rpm. Further a mixture of 4 g AI (OFM), 5 g of Soybean oil, and 50 mg of BHT is adsorbed on to mesoporous silica/Carbon HBT combination and then added under stirring to the molten waxy liquid and kept under continuous stirring for about 10-15 minutes. Another solution called aqueous phase is prepared in a separate vessel by melting 4.65 g of span 60 and 5.35 tween 60 in 34 g of 4.5% polyvinyl alcohol solution. This hot aqueous phase is mixed in the molten wax under stirring at 85° C. and homogenise at 2000 rpm using laboratory homogeniser. After mixing, resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5.

### Example P-5: Preparation of Semi-Solid Composition with 4% AI—TML

26 g of carnauba wax, 4 g of microcrystalline wax, 5 g of olive oil and 2 g of stearic acid mixed together in a glass vessel equipped with suitable size propeller, and heated at about 85° C. and kept under stirring at 700 rpm. 2.9 g of Magnesium stearate is added in the same vessel under stirring at 700 rpm. Further a mixture of 4 g AI (TML), 3 g of olive oil, and 50 mg of BHT mixed with mesoporous mesoporous silica/Carbon HBT combination and added into liquid wax and kept under continuous stirring at 700 rpm and mix for 10-15 minutes. Another solution called aqueous phase is prepared in a separate vessel by melting 4.31 g of span 60 and 5.69 g of tween 60 in 36.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C., 5 g of propylene glycol containing 120 mg of methyl paraben is added and further allowed to cool at mom temperature. pH of the pasty material is adjusted in the range of 5.5 to 6.5.

### Example P-6: Preparation of Semi-Solid Composition with 1% AI—TUTA

A mixture of 26 g of microcrystalline wax and 6 g of carnauba wax, 5 g of Soybean oil and 2.g of stearic acid is charged in glass vessel, and heated at 80-85° C. in water bath under stirring to obtain liquid wax. 2.9 g of Magnesium stearate is added in the same vessel under stirring Further a mixture of 1 g AI (TUTA), 3 g of Soybean oil, and 50 mg of BHT is adsorbed on to mesoporous silica/Carbon HBT combination and then added under stirring to the molten waxy liquid and kept under continuous stirring for about 10-15. Another solution called aqueous phase is prepared in a separate vessel by melting 4.46 g of span 60 and 5.55 g of tween 60 in 37.5 g of 4.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5.

### Example P-7: Preparation of Semi-Solid Composition with 4% AI—FAW

26 g of microcrystalline wax, 6 g of carnauba wax, 3 g of soybean oil and 2 g of cetostearyl alcohol are mixed together, charged in glass vessel, and heated at 80-85° C. in water bath, under stirring to obtain waxy liquid. 2.9 g of Magnesium stearate is added in the same vessel under stirring at 700 rpm. Further a mixture of 4 g AI (FAW), 6 g of Soybean oil, and 50 mg of BHT is adsorbed on to mesoporous silica/Carbon HBT combination and then added under stirring to the molten waxy liquid and kept under continuous stirring for about 10-15. Another solution called aqueous phase is prepared in a separate vessel by melting 4.46 g of span 60 and 5.55 g of tween 60 in 33.5 g of 4.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5 using 10% HCl solution.

### Example P-8: Preparation of Semi-Solid Composition with 4% AI—PBW

A mixture of 26 g of microcrystalline wax, 6 g of montanic acid, and 8 g of soybean oil is charged in glass vessel, and heated at 80-85° C. in water bath, under stirring to obtain liquid wax. 2.9 g of Magnesium stearate is added in the same vessel under stirring at 700 rpm. Further a mixture of 4 g AI (PBW), 2 g of Soybean oil, and 50 mg of BHT is adsorbed on to mesoporous silica/Carbon HBT combination and then added under stirring to the molten waxy liquid and kept under continuous stirring for about 10-15. Another solution called aqueous phase is prepared in a separate vessel by melting 4.46 g of span 60 and 5.55 g of tween 60 in

35.5 g of 4.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5.

### Example P-9: Preparation of Semi-Solid Composition with 4% AI—RYSB

26 g of microcrystalline wax, 4 g of Soybean oil, and 3 g of stearic acid and 3 g of carnauba wax are mixed together in a glass vessel equipped with suitable size propeller, heated at about 85° C. and kept under stirring at 700 rpm. 2.9 g of Magnesium stearate is added in the same vessel under stirring at 700 rpm. Further a mixture of 4 g AI (RYSB), 0.5 g of Compritol 888ATO, 3 g of Soybean oil, and 50 mg of BHT is adsorbed on to mesoporous silica/Carbon HBT combination and then added under stirring to the molten waxy liquid and kept under continuous stirring for about 10-15. Another solution called aqueous phase is prepared in a separate vessel by melting 5.74 g of span 60 and 7.68 tween 60 in 33.51 g of 4.5% polyvinyl alcohol solution. This aqueous phase is mixed in the molten wax under stirring at 85° C. and homogenise at 2000 rpm using laboratory homogeniser. After mixing, the resulting mixture is allowed to cool to 65° C. After attaining 65° C., 5 g of propylene glycol containing 120 mg of methyl paraben is added and further allowed to cool at room temperature. pH of the pasty material is adjusted in the range of 5.5 to 6.5 using 10% HCl solution.

What is claimed is:

1. A semiochemical composition that is a semi-solid oil-in-water emulsion, comprising a dispersed phase and a dispersion medium,
wherein the dispersed phase comprises:
semiochemical,
wax,
mesoporous material, present in an amount of up to 10 w/w % of the dispersed phase,
long chain saturated or unsaturated fatty acid or/and alcohol, in an amount up to 10 w/w % of dispersed phase,
diluent, and
antioxidant, and
wherein the dispersion medium comprises:
additive, present in an amount of about 2 to 30 w/w % of the total amount of the dispersion medium,
wherein the composition exhibits one or more of the following properties (i)-(iv):
(i) rainfastness;
(ii) non-phytotoxicity to plant surface;
(iii) controlled release of semiochemical(s) for a minimum of about eight weeks; and
(iv) stability and controlled release of semiochemical(s) under fluctuations in environmental conditions.

2. The composition of claim 1, wherein the composition exhibits all four properties (i)-(iv).

3. The composition of claim 1, wherein the dispersed phase and dispersion medium are present in a 1:1 weight ratio.

4. The composition of claim 1, wherein the dispersed phase is present in an amount of about 50 w/w % of the total composition, and the dispersion medium is present in an amount about 50 w/w %.

5. The composition of claim 1, wherein the semiochemical is present either alone or encapsulated in a polymer matrix or both, or in microcapsules with core-shell structure, or premixed with or adsorbed into the mesoporous material, or embedded in wax, or any combination thereof, present in an amount of about 0.1 to 20 w/w %;
wherein the wax is present in an amount of about 0.1 to 50 w/w % of the total composition;
wherein the long chain saturated or unsaturated long chain fatty acid/alcohol is present in an amount of about 0.1 to 20 w/w % of the total composition;
wherein the diluent is present in an amount of about 0.1 to 15 w/w % of the total composition; and
wherein the antioxidant is present in an amount of about 0.01 to 6 w/w % of the total composition.

6. The composition of claim 1, further comprising a lubricant or texture modifier present in an amount of about 0.1 to 10 w/w % of the total composition.

7. The composition of claim 6, wherein the lubricant or texture modifier comprises metallic stearate.

8. The composition of claim 6, wherein the lubricant or texture modifier comprises magnesium stearate, zinc stearate, or calcium stearate, or a combination thereof.

9. The composition of claim 1, wherein the dispersion medium further comprises emulsifier, present in an amount of about 0.1 w/w % to 20 w/w % by of the total amount of dispersion medium.

10. The composition of claim 1, wherein the antioxidant is BHT, BHA or tocopherol, or any combination thereof.

11. The composition of claim 1, wherein additive comprise stabilizer, humectant, preservative, rheology modifier, adhesion promoter or film former, or UV screening agent, or any combinations thereof.

12. The composition of claim 1, wherein the additive comprises:
film forming or adhesion promoting agent, present in an amount in the range of about 0.1 to 7.5 w/w % of the total amount of the composition;
preservative, present in an amount of about 0.01 to 0.5 w/w % of the total amount of the composition;
stabilizer, present in an amount of about 0.1 to 10 w/w % of the total amount of the dispersion medium;
UV screening agent and controlled release materials, present in an amount of about 0.1 to 10 w/w % of the total amount of the composition; and
rheology modifier, present in an amount of about 0.1 to 10 w/w % of the total amount of the composition.

13. The composition of claim 12, wherein the film forming or adhesion promoting agent comprises poly vinyl pyrrolidone, or poly vinyl alcohol solution, or a combination thereof.

14. The composition of claim 12, wherein the stabilizer comprises ethylene glycol, diethylene glycol, propylene glycol, or glycerol, or any combination thereof.

15. The composition of claim 12, wherein the preservative is methyl paraben, propyl paraben, sodium benzoate, or potassium sorbate, or any combination thereof.

16. The composition of claim 12, wherein the UV screening agent comprises activated charcoal, carbon powder or carbon HBET, or any combination thereof.

17. The composition of claim 1, wherein one or more semiochemical(s) is a pheromone, an allomone, a kairomone, or a synomone, or any combination thereof.

18. The composition of claim 1, wherein the mesoporous material used for premix or adsorption of semiochemical(s) is Carbon HBET, optionally used in combination with mesoporous silica, wherein the semiochemical and the mesoporous are in a % eight ratio from 1:10 to 10:1.

19. The composition of claim 1, wherein the mesoporous material has a surface area of about 2000 m²/g measured using nitrogen adsorption method.

20. The composition of claim 1, wherein wax comprises natural wax or synthetic wax, or a combination thereof.

21. The composition of claim 20, wherein the synthetic wax comprises microcrystalline wax, ozokerite, ceresin, montane wax, or paraffin, or any combination thereof.

22. The composition of claim 20, wherein the natural wax comprises rice bran wax, sunflower wax, bees wax, candelilla wax, carnauba wax, Chinese insect wax, esparto wax, Japan wax, spermaceti wax, or lanolin wax, or any combination thereof.

23. The composition of claim 1, wherein the semiochemical is encapsulated in natural or synthetic polymer comprising gelatine, alginates, chitin, aminoplast resin, the alkoxy cellulose or its derivatives, poly urea derivatives, polyacrylates or waxes.

24. The composition of claim 1, wherein the semiochemical comprises:
a blend of (Z, Z)-7,11-hexadecadien-1-yl acetate and (Z, E)-7,11-hexadecadien-1-yl acetate;
a blend of Z9-Tetradecenyl acetate, Z7-Dodecenyl acetate and Z11-Hexadecenyl acetate;
a blend of E-11-hexadecen-1-yl acetate and (E)-11-hexadecen-1-ol;
a blend of 3E,8Z,11Z-Tetradecatrienyl acetate and 3E,8Z-Tetradecadienyl acetate;
(Z,Z,E)-7,11,13-Hexadeca trien-1-al;
a blend of Z-11-Hexadecenal, Z-11-Hexadecenyl-1-acetate and Z-11-Hexadecenol;
a blend of Z-11-Hexadecenal and Z-9-Hexadecenal;
a blend of Z-11-Hexadecenal and Z-9-Hexadecenal;
a blend of (Z,E)-9,11-Tetradecadienyl acetate and Z9,E-12-Tetradecadienyl acetate;
a blend of Cis-3-Hexenyl acetate and 2E-Hexen-1-ol;
a blend of Z-11-Hexadecenyl-1-acetate and Z-11-Hexadecenol;
Z-11-Hexadecenol;
(7Z,9E)-Dodeca-7,9,11-trien-1-yl formate;
11Z,13Z-Hexadeca dienal;
a blend of 4-methyl-5-nonanol and 4-methyl-5-nonanone;
ethyl-4-Methyl octanoate;
methyl eugenol;
a blend of methyl eugenol and cuelure;
(E,E)-8,10-Dodecadien-1-ol;
a blend of (Z)-8-Dodecen-1-yl acetate, (E)-8-Dodecen-1-yl-acetate and (Z)-8-Dodecen-1-ol;
(1R)-cis-4,6,6-Trimethylbicyclo [3.1.1]hept-3-en-2-one;
a blend of trans-3,7-Dimethyl-2,6-octadien-1-ol and cis-3,7-Dimethyl-2,6-octadien-1-ol;
a blend of Z-13-Octadecynyl acetate and Z-13-Octadecenol;
a blend of (E,E)-10,12-hexadecadienal, (E,E)-10,12-hexadecadienol and E-10-hexadecenal;
a blend of Z,E-9,12-Tetradecadien-1-yl-Acetate and Z-9 Tetradecenol;
a blend of (Z)-8-Dodecen-1-yl acetate and (E)-8-Dodecen-1-yl-acetate;
(7E,9Z) dodeca-7,9-dien-1-yl acetate;
4-vinyl Anisole;
Methyl Isonicotinate; or
a blend of Mono terpenes and Terpene alcohols;
or any combination of the foregoing.

25. The composition of claim 1, wherein the semiochemical comprises:
(Z, Z)-7, 11-hexadecadien-1-yl acetate and (Z, E)-7, 11-hexadecadien-1-yl acetate;
Z 9-Tetradecenyl acetate, Z7-Dodecenyl acetate and Z11-Hexadecenyl acetate;
Methyl eugenol;
Culure;
(E,E)-8,10-Dodecadien-1-ol;
Z-11-Hexadecenal and Z-9-Hexadecenal;
or any combination of the foregoing.

26. The composition of claim 1, wherein the long chain saturated fatty acids/alcohol comprises cetostearyl alcohol, cetyl alcohol, stearyl alcohol, stearic acid, montanic acid, oleic acid, or polyhydroxy alcohol, or any combination thereof.

27. The composition of claim 1, wherein the composition further comprises emulsifier, and the emulsifier comprises phospholipid, Polyoxyethylene Sorbitan Monolaurate, Sorbitan Monostearate, sorbitan monoleate, Polyoxyethylene Lauryl Ether, Polyoxyethylene glycol octadecyl ether, Polyoxyethylene Sorbitan Monolaurate, polyoxyethylene sorbitan monooleate or any combination thereof.

28. The composition of claim 1, wherein the diluent comprises paraffin oil, soybean oil, cotton seed oil, olive oil, jojoba oil, sunflower oil, corn oil, peanut oil, sesame oil, castor oil, medium chain triglycerides, or isopropyl palmitate, or any combination thereof.

29. A method of controlling pests affecting plants in a field, comprising:
applying the semiochemical composition of claim 1 in the field at or near a plant in the field to decrease the population of pests affecting plants in the field.

30. A method for preparing a semi-solid emulsion composition, the method comprising:
(a) preparing a dispersed phase, comprising
(a-1) mixing a wax, about 10% of a diluent, and saturated or unsaturated fatty acid and/or alcohol at the melting temperature of mixture to obtain a molten waxy liquid; and
(a-2) dispersing a semiochemical which is alone, adsorbed on mesoporous silica and carbon HBET, or encapsulated along with a diluent, an antioxidant, and a texture modifier, in the molten waxy liquid;
(b) preparing a dispersion medium, comprising
preparing an aqueous phase by mixing aqueous adhesion promoter polymer solution and emulsifier under stirring at same temperature to the melting temperature of wax blend; and
(c) mixing the aqueous phase obtained in step (b) with the mixture obtained in (a) using bottom or laboratory homogenizer to obtain the semiochemical composition.
